(19) United States
(12) Patent Application Publication
(10) Pub. No.: US 2011/0255602 A1
(43) Pub. Date: Oct. 20, 2011

(54) IMAGE PROCESSING APPARATUS, IMAGE PROCESSING METHOD, AND PROGRAM

(75) Inventors: Kenji Kondo, Tokyo (JP); Junichi Tanaka, Kanagawa (JP)

(73) Assignee: SONY CORPORATION, TOKYO (JP)

(21) Appl. No.: 13/131,814

(22) PCT Filed: Dec. 31, 2009
(86) PCT No.: PCT/JP09/70295

§ 371 Date: May 27, 2011

(30) Foreign Application Priority Data
Dec. 3, 2008 (JP) 2008-308218

(51) Int. Cl. H04N 7/32

(52) U.S. Cl. 375/240.16; 375/E07.243

(57) ABSTRACT

The present invention relates to an image processing apparatus, an image processing method, and a program capable of increasing the quality of a predicted image generated through inter prediction even when a motion compensation process with integer-pel accuracy is performed.

A computing unit 115 decodes a transform coefficient subjected to inverse orthogonal transform and supplied from an inverse orthogonal transform unit 114 by adding the transform coefficient to an inter predicted image supplied from a switch 214. A motion prediction/compensation unit 212 performs motion compensation on the decoded image. An FIR filter 213 performs a filter process on the motion-compensated image using a filter coefficient corresponding to a compressed image and transmitted from an image encoding apparatus. The filter coefficient is obtained using the least-square method when the compressed image is generated. The FIR filter 213 supplies the filtered image to the switch 214 as the inter predicted image. The present invention is applicable to an image decoding apparatus that performs decoding using, for example, the H.264/AVC standard.

### TECHNICAL FIELD

The present invention relates to an image processing apparatus, an image processing method, and a program and, in particular, to an image processing apparatus, an image processing method, and a program capable of increasing the quality of a predicted image generated through inter prediction even when a motion compensation process with integer-pel accuracy is performed.

### BACKGROUND ART

In recent years, apparatuses that manipulate image information in a digital format and, at that time, in order to transfer and accumulate the information efficiently, compression-encode an image have been in widespread use. The apparatuses use the redundancy that is specific to image information and employ a method for compressing the image on the basis of orthogonal transform, such as discrete cosine transform, and motion compensation (e.g., the MPEG (Moving Picture Experts Group phase) standard).

In particular, MPEG2(ISO/IEC 13818-2) is defined as a general-purpose image encoding method. MPEG2 is a standard defined for interlacing scanned images and progressive scanned images and for standard-definition images and high-definition images. MPEG2 is widely used for professional and consumer applications nowadays. By using the MPEG2 compression standard and assigning an amount of coding (a bit rate) of 4 to 8 Mbps to a standard resolution interlacing image of 720×480 pixels and an amount of coding of 18 to 22 Mbps to a high-definition interlacing image of 1920×1088 pixels, a high compression ratio and an excellent image quality can be realized.

MPEG2 is intended to provide high-resolution encoding that mainly accommodates with broadcasting and, thus, MPEG2 does not support a coding method having an amount of coding lower than that of MPEG1, that is, a compression ratio higher than that of MPEG1. However, as cell phones are becoming more widely used, the need for such an encoding method is increasing. Accordingly, the MPEG4 coding method has been standardized. For example, the MPEG4 image coding method was approved as the international standard ISO/IEC 14496-2 in December, 1998.

In addition, in recent years, in order to encode an image for TV conferences, standardization of the standard called H.26L (ITU-T Q6/16 VCEG) has been progressing. In H.26L, a large amount of computation is required for encoding and decoding operations, as compared with existing coding standards, such as MPEG2 and MPEG4. However, it is known that H.26L can realize a higher coding efficiency. Furthermore, standardization called Joint Model of Enhanced-Compression Video Coding has been progressing as part of the activities of MPEG4. The Joint Model of Enhanced-Compression Video Coding is based on H.26L and includes functions that are not supported by H.26L and, thus, a higher coding efficiency can be realized. The Joint Model of Enhanced-Compression Video Coding was approved as an international standard in March, 2003, as H.264 and MPEG-4 Part10 (Advanced Video Coding; Hereinafter, referred to as “AVC”).

In addition, in, for example, H.264/AVC, inter prediction is performed using a correlation between frames or fields. In a motion compensation process performed in inter prediction, a predicted image is generated using inter prediction (hereinafter referred to as an “inter predicted image”) by using a partial area of a prestored referenceable image.

For example, as shown in FIG. 1, if five frames of a prestored referenceable image are selected as reference frames, part of an inter predicted image of a frame to be inter predicted (an original frame) is generated by referencing part of one of the five reference frames (hereinafter referred to as a “reference image”). Note that the position of part of the reference image serving as part of the inter predicted image is determined by a motion vector detected on the basis of the images of the reference frame and the original frame.

More specifically, as shown in FIG. 2, when a face 11 in a reference frame is moved in the original image in the lower right direction and if about ⅓ of the lower portion thereof is hidden, a motion vector indicating the upper left direction, which is the opposite of the lower right direction, is detected. Thus, part 12 of the face 11 that is not hidden in the original frame is generated by referencing part 13 of the face 11 in the reference frame at a position obtained by moving the part 11 by the motion indicated by the motion vector.

In addition, in a motion compensation process of H.264/AVC, the resolution for a motion vector can be increased to fractional-pel accuracy, such as ½-pel accuracy or ¼-pel accuracy.

In such a compensation process with fractional-pel accuracy, a virtual pixel called a Sub-Pel is assumed to exist between two neighboring pixels, and a process for generating the Sub-Pel (hereinafter referred to as “interpolation”) is additionally performed. That is, in the motion compensation process with fractional-pel accuracy, since a minimum resolution of the motion vector is a pixel at a fractional position, interpolation is performed in order to generate a pixel at a fractional position.

FIG. 3 illustrates pixels of an image in which the numbers of pixels in the vertical direction and the horizontal direction are increased to four times the original numbers by interpolation. Note that in FIG. 3, a white square represents a pixel at an integer position, while a shaded square represents a pixel at a fractional position. In addition, the alphabetical character written in the square represents the pixel value of the pixel indicated by the square.

Pixel values b, h, j, a, d, f, and r of pixels generated through interpolation and located at fractional positions are expressed using the following equations (1).

b=(E−5F+20G+20H−5I+J)/32

h=(A−5C+20G+20M−5R+T)/32

j=(aa−5bb+20b+20s−5gg+hh)/32

a=(G+b)/2

d=(G+h)/2

f=(b+j)/2

r=(m+s)/2 (1)

Note that like the pixel value b, pixel values aa, bb, s, gg, and hh can be computed. Like the pixel value h, pixel values cc, dd, m, ee, and ff can be computed. Like the pixel value a, pixel value c can be computed. Like the pixel value d, pixel values f, n, and q can be computed. Like the pixel value r, pixel values e, p, and g can be computed.

The above-described equation (1) is employed for interpolation of, for example, the H.264/AVC standard. Such an equation differs in accordance with the standards. However, the purposes of the equations are the same. This equation can be realized by using an FIR (Finit-duration Impulse Response) filter having an even number of taps.

In addition, in NPLs 1 and 2, an adaptive interpolation filter (AIF) is described as a recent research report. In a motion compensation process using such an AIF, the effect of aliasing and encoding distortion can be reduced by adaptively changing the filter coefficients of an FIR filter having an even number of taps and used in the interpolation. Thus, an error in the motion compensation can be reduced.

Note that in addition to an AIF, recently, an adaptive loop filter (ALF) has been developed as a next-generation video encoding technique (refer to, for example, NPL 3). By using such an adaptive filter, an optimal filter process is performed for each of the frames. Thus, block distortion that cannot be fully removed by a deblocking filter and distortion caused by quantization can be reduced.

### CITATION LIST

### Non Patent Literature

NPL 1: Thomas Wedi and Hans Georg Musmann, Motion- and Aliasing-Compensated Prediction for Hybrid Video Coding, IEEE Transactions on circuits and systems for video technology, July 2003, Vol. 13, No. 7
NPL 2: Yuri Vatis, Joern Ostermann, Prediction of P- and B-Frames Using a Two-dimensional Non-separable Adaptive Wiener Interpolation Filter for H.264/AVC, ITU-T SG16 VCEG 30th Meeting, Hangzhou China, October 2006
NPL 3: Yi-Jen Chiu and L. Xu, “Adaptive (Wiener) Filter for Video Compression,” ITU-T SG16 Contribution, C437, Geneva, April 2008

### SUMMARY OF INVENTION

### Technical Problem

However, in a motion compensation process with integer-pel accuracy and a motion compensation process with fractional-pel accuracy using an FIR filter, the pixel values of a reference frame are only directly copied to the positions corresponding to the motion vector in the inter predicted image. Accordingly, in many cases, an inter predicted image is not completely the same as an image to be inter predicted. In addition, since the difference between an inter predicted image and an image to be inter predicted needs to be sent to the decoding side, the coding efficiency decreases if the difference is large.

Note that one of the reasons why an inter predicted image is not completely the same as an image to be inter predicted is that there is a quantization error that occurs when the reference image is encoded or an error in the motion vector.

A motion compensation process with fractional-pel accuracy using an AIF can reduce the encoding distortion. However, since an AIF is a filter for performing interpolation, an AIF cannot be applied to a motion compensation process with integer-pel accuracy in which interpolation is not performed.

Accordingly, the present invention is intended to increase the quality of an inter predicted image even when a motion compensation process with integer-pel accuracy is performed.

### Solution to Problem

According to a first aspect of the present invention, an image processing apparatus includes decoding means for decoding an encoded image, filter processing means for performing a filter process on one of the image decoded by the decoding means and the motion compensated image using a filter coefficient transmitted from a different image processing apparatus that encoded the image and corresponding to the encoded image, where the filter coefficient is obtained so that one of a reference image of the image and a motion-compensated reference image is made to be similar to the image prior to an encoding process when the image is encoded, motion compensating means for performing motion compensation on one of the image filtered by the filter processing means and the image decoded by the decoding means, and computing means for generating a decoded image by summing the image decoded by the decoding means and one of the filtered image that is motion-compensated by the motion compensating means and the motion-compensated image that is filtered by the filter processing means.

The filter processing means can perform a filter process on the image decoded by the decoding means, and the motion compensating means can perform motion compensation on the image filtered by the filter processing means. The computing means can generate the decoded image by summing the image decoded by the decoding means and the filtered image that is motion-compensated by the motion compensating means.

The motion compensating means can perform motion compensation on the image decoded by the decoding means, and the filter processing means can perform a filter process on the image that is motion-compensated by the motion compensating means. The computing means can generate the decoded image by summing the image decoded by the decoding means and the motion-compensated image that is filtered by the filter processing means.

The filter coefficient can be obtained using a least square method when the image is encoded so that the square of a difference between the image prior to encoding and one of a reference image of the image and the motion compensated reference image is minimized.

The filter coefficient and the encoded image can be lossless-encoded and transmitted from the different image processing apparatus in the form of compression information. The decoding means can lossless-decode the compression information, extract the filter coefficient and the encoded image from the resultant information, and decode the encoded image, and the filter processing means can perform a filter process on one of the image decoded by the decoding means and the motion-compensated image using the filter coefficient extracted by the decoding means.

According to a first aspect of the present invention, an image processing method for use in an image processing apparatus includes a decoding step of decoding an encoded image, a filter processing step of performing a filter process on one of the image decoded by the decoding means and the motion compensated image using a filter coefficient transmitted from a different image processing apparatus that encoded the image and corresponding to the encoded image, where the filter coefficient is obtained so that one of a reference image of the image and a motion-compensated image is made to be similar to the image prior to an encoding process when the image is encoded, a motion compensating step of performing motion compensation on one of the image filtered in the filter processing step and the image decoded in the decoding step, and a computing step of generating a decoded image by summing the image decoded in the decoding step and one of the filtered image that is motion-compensated in the motion compensating step and the motion-compensated image that is filtered in the filter processing step.

According to a first aspect of the present invention, a program for causing a computer to function as an image processing apparatus is provided. The image processing apparatus includes decoding means for decoding an encoded image, filter processing means for performing a filter process, using a filter coefficient transmitted from a different image processing apparatus that encoded the image and corresponding to the encoded image, the filter coefficient being obtained so that one of a reference image of the image and a motion-compensated image is made to be similar to the image prior to an encoding process when the image is encoded, on one of the image decoded by the decoding means and the motion compensated image, motion compensating means for performing motion compensation on one of the image filtered by the filter processing means and the image decoded by the decoding means, and computing means for generating a decoded image by summing the image decoded by the decoding means and one of the filtered image that is motion-compensated by the motion compensating means and the motion-compensated image that is filtered by the filter processing means.

According to a second aspect of the present invention, an image processing apparatus includes filter coefficient computing means for computing, using an image to be encoded and one of a reference image and a motion-compensated reference image, a filter coefficient of a filter that makes one of the reference image and the motion-compensated reference image be similar to the image to be encoded, filter processing means for performing a filter process on one of the reference image and the motion-compensated reference image using the filter coefficient computed by the filter coefficient computing means, motion compensating means for detecting, using one of the filtered reference image and the reference image, a motion vector between the image to be encoded and one of the filtered reference image and the reference image and performing motion compensation on one of the filtered reference image and the reference image on the basis of the motion vector, encoding means for generating the encoded image using a difference between the image to be encoded and one of the motion-compensated filtered reference image and the filtered motion-compensated reference image, and transmitting means for transmitting the encoded image and the filter coefficient.

The filter coefficient computing means can compute the filter coefficient of a filter that makes the reference image be similar to the image to be encoded on the basis of the image to be encoded and the reference image. The filter processing means can perform a filter process on the reference image using the filter coefficient, and the motion compensating means can detect a motion vector between the image to be encoded and the filtered reference image and perform motion compensation on the filtered reference image on the basis of the motion vector. The encoding means can generate the encoded image using a difference between the motion-compensated filtered image and the image to be encoded.

The motion compensating means can detect, using the image to be encoded and the reference image, a motion vector between the image to be encoded and the reference image and perform motion compensation on the reference image on the basis of the motion vector. The filter coefficient computing means can compute a filter coefficient of a filter that makes the motion-compensated reference image be similar to the image to be encoded on the basis of the image to be encoded and the motion-compensated reference image, and the filter processing means performs a filter process on the motion-compensated reference image using the filter coefficient. The encoding means can generate the encoded image using a difference between the filtered motion-compensated reference image and the image to be encoded.

The filter coefficient computing means can compute the filter coefficient using a least square method so that the square of a difference between the image to be encoded and one of the reference image and the motion-compensated reference image is minimized.

The filter coefficient computing means can compute the filter coefficient using a pixel value of one of the reference image and the motion-compensated reference image with integer-pel accuracy and a pixel value of one of the reference image and the motion-compensated reference image with fractional-pel accuracy.

The transmitting means can lossless-encode the encoded image and the filter coefficient and transmit the encoded image and the filter coefficient in the form of compression information.

According to a second aspect of the present invention, an image processing method for use in an image processing apparatus is provided. The method includes a filter coefficient computing step of computing, using an image to be encoded and one of a reference image and a motion-compensated image, a filter coefficient of a filter that makes one of the reference image and the motion-compensated image be similar to the image to be encoded, a filter processing step of performing a filter process on one of the reference image and the motion-compensated image using the filter coefficient computed in the filter coefficient computing step, a motion compensating step of detecting, using one of the filtered reference image and the reference image, a motion vector between the image to be encoded and one of the filtered reference image and the reference image and performing motion compensation on one of the filtered reference image and the reference image on the basis of the motion vector, an encoding step of generating the encoded image using a difference between the image to be encoded and one of the motion-compensated filtered reference image and the filtered motion-compensated reference image, and a transmitting step of transmitting the encoded image and the filter coefficient.

According to a second aspect of the present invention, a program for causing a computer to function as an image processing apparatus is provided. The image processing apparatus includes filter coefficient computing means for computing, using an image to be encoded and one of a reference image and a motion-compensated reference image, a filter coefficient of a filter that makes one of the reference image and the motion-compensated reference image be similar to the image to be encoded, filter processing means for performing a filter process on one of the reference image and the motion-compensated reference image using the filter coefficient computed by the filter coefficient computing means, motion compensating means for detecting, using the image to be encoded and one of the filtered reference image and the reference image, a motion vector between the image to be encoded and one of the filtered reference image and the reference image and performing motion compensation on one of the filtered reference image and the reference image on the basis of the motion vector, encoding means for generating the encoded image using a difference between the image to be encoded and one of the motion-compensated filtered reference image and the filtered motion-compensated reference image, and transmitting means for transmitting the encoded image and the filter coefficient.

According to the first aspect of the present invention, an encoded image is decoded, and a filter process is performed, using a filter coefficient transmitted from a different image processing apparatus that encoded the image and corresponding to the encoded image, where the filter coefficient is obtained so that one of a reference image of the image and a motion-compensated reference image is made to be similar to the image prior to an encoding process when the image is encoded, on one of the image decoded by the decoding means and the motion compensated image. In addition, motion compensation is performed on one of the image filtered by the filter processing means and the image decoded by the decoding means. Thereafter, a decoded image is generated by summing the image that is decoded and one of the filtered image that is motion-compensated and the motion-compensated image that is filtered.

According to the second aspect of the present invention, a filter coefficient of a filter that makes one of the reference image and the motion-compensated reference image be similar to the image to be encoded is computed using an image to be encoded and one of a reference image and a motion-compensated reference image, and a filter process is performed on one of the reference image and the motion-compensated reference image using the computed filter coefficient. In addition, using the image to be encoded and one of the filtered reference image and the reference image, a motion vector between the image to be encoded and one of the filtered reference image and the reference image is detected, and motion compensation is performed on one of the filtered reference image and the reference image on the basis of the motion vector. Thereafter, the encoded image is generated using a difference between the image to be encoded and one of the motion-compensated filtered reference image and the filtered motion-compensated reference image, and the encoded image and the filter coefficient are transmitted.

### Advantageous Effects of Invention

According to the present invention, even when a motion compensation process with integer-pel accuracy is performed, the quality of a predicted image generated through inter prediction can be increased.

### BRIEF DESCRIPTION OF DRAWINGS

FIG. 1 illustrates an existing inter prediction technique.

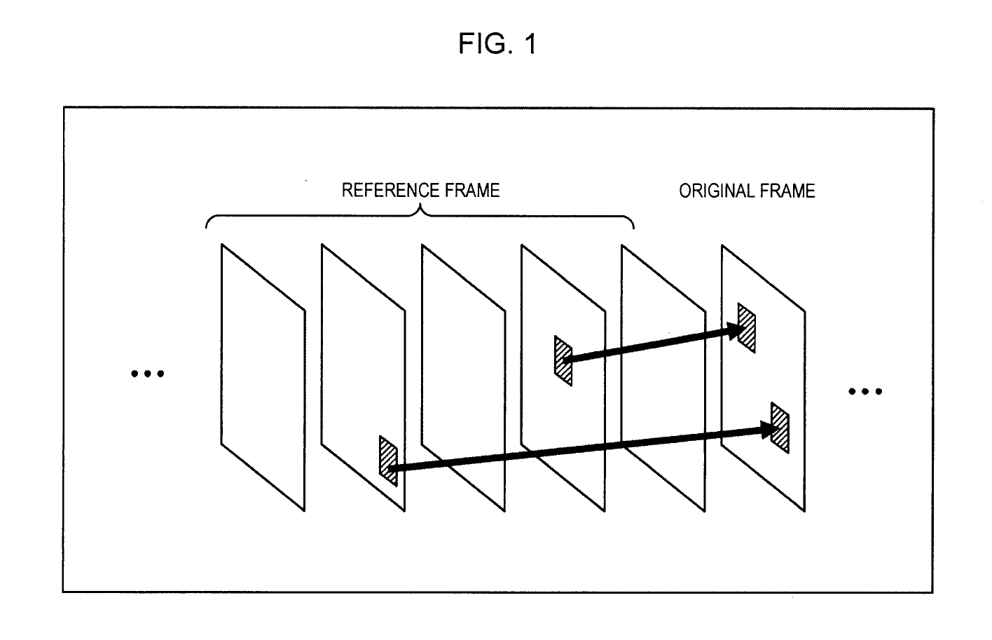

FIG. 2 illustrates an existing inter prediction technique in detail.

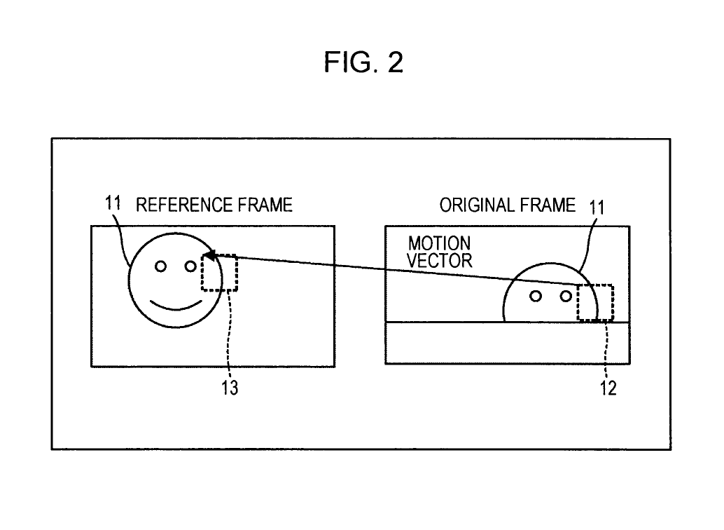

FIG. 3 illustrates interpolation.

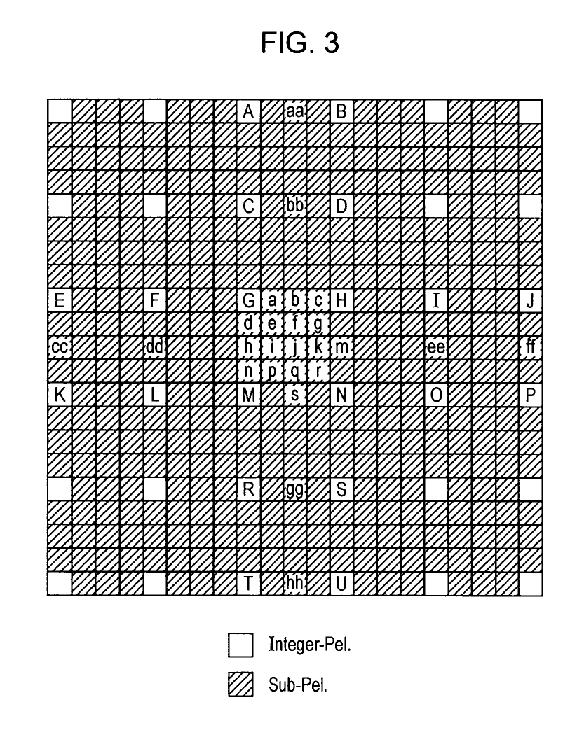

FIG. 4 is a block diagram of the configuration of an image encoding apparatus according to the present invention.

FIG. 5 illustrates a variable block size.

FIG. 6 is a block diagram of the configuration of an image decoding apparatus according to the present invention.

FIG. 7 is a block diagram of an example of the configuration of an image encoding apparatus according to an embodiment of the present invention.

FIG. 8 is a flowchart of an encoding process performed by the image encoding apparatus shown in FIG. 7.

FIG. 9 is a block diagram of an example of the detailed configuration around a filter coefficient computing unit and an FIR filter.

FIG. 10 is a block diagram of another example of the detailed configuration around a filter coefficient computing unit and an FIR filter.

FIG. 11 is a block diagram of an example of the configuration of an image decoding apparatus according to an embodiment of the present invention.

FIG. 12 is a flowchart of a decoding process performed by the image decoding apparatus shown in FIG. 11.

FIG. 13 is a block diagram of an example of the configuration corresponding to the image decoding apparatus shown in FIG. 10 according to the present invention.

FIG. 14 illustrates an example of an extended block size.

FIG. 15 is a block diagram of an example of the primary configuration of a television receiver according to the present invention.

FIG. 16 is a block diagram of an example of a primary configuration of a cell phone according to the present invention.

FIG. 17 is a block diagram of an example of the primary configuration of a hard disk recorder according to the present invention.

FIG. 18 is a block diagram of an example of the primary configuration of a camera according to the present invention.

### DESCRIPTION OF EMBODIMENTS

### 1. Basics of Invention

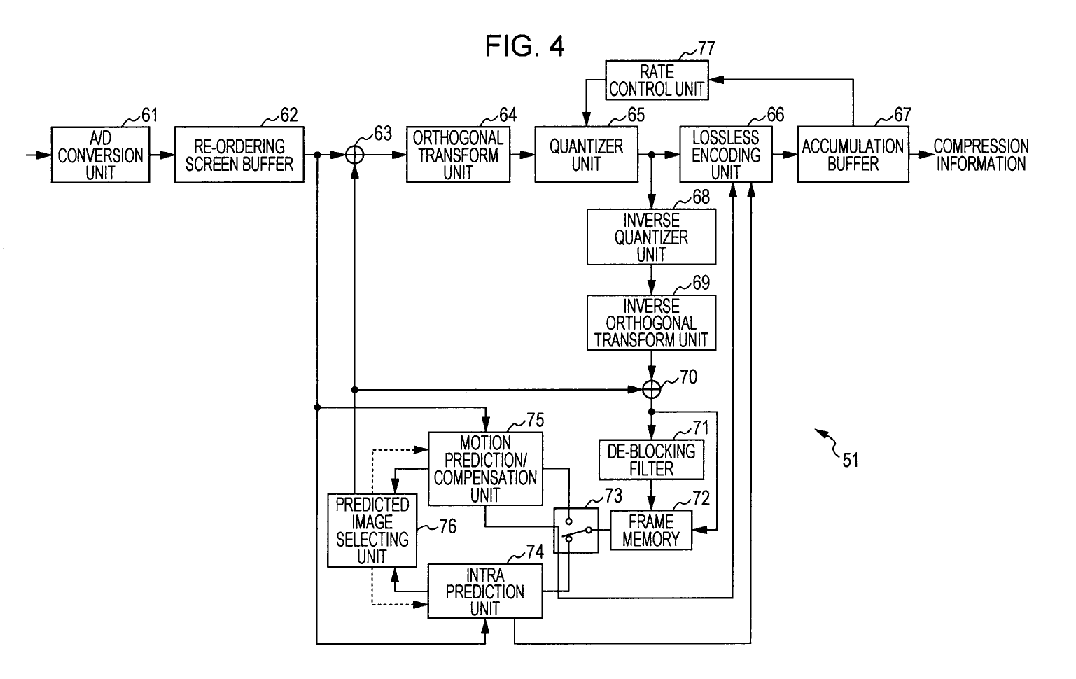

An image encoding apparatus and an image decoding apparatus that are basic apparatuses of the present invention are described first with reference to FIGS. 4 to 6.

FIG. 4 illustrates the configuration of an image encoding apparatus that is a basic apparatus of the present invention. An image encoding apparatus 51 includes an A/D conversion unit 61, a re-ordering screen buffer 62, a computing unit 63, an orthogonal transform unit 64, a quantizer unit 65, a lossless encoding unit 66, an accumulation buffer 67, an inverse quantizer unit 68, an inverse orthogonal transform unit 69, a computing unit 70, a de-blocking filter 71, a frame memory 72, a switch 73, an intra prediction unit 74, a motion prediction/compensation unit 75, a predicted image selecting unit 76, and a rate control unit 77. The image encoding apparatus 51 compression-encodes an image using, for example, the H.264/AVC standard.

The A/D conversion unit 61 A/D-converts an input image and outputs a converted image into the re-ordering screen buffer 62, which stores the converted image. Thereafter, the re-ordering screen buffer 62 re-orders, in accordance with the GOP (Group of Picture), the images of frames arranged in the order in which they are stored for displaying so that the images are arranged in the order in which the frames are to be encoded.

The computing unit 63 subtracts, from the image read from the re-ordering screen buffer 62, one of the following two predicted images selected by the predicted image selecting unit 76: an intra predicted image and a predicted image generated through inter prediction (hereinafter referred to as an “inter predicted image”). Thereafter, the computing unit 63 outputs the resultant difference to the orthogonal transform unit 64. The orthogonal transform unit 64 performs orthogonal transform, such as discrete cosine transform or Karhunen-Loeve transform, on the difference received from the computing unit 63 and outputs the transform coefficient. The quantizer unit 65 quantizes the transform coefficient output from the orthogonal transform unit 64.

The quantized transform coefficient output from the quantizer unit 65 is input to the lossless encoding unit 66. In the lossless encoding unit 66, a lossless encoding process, such as variable-length coding (e.g., CAVLC (Context-based Adaptive Variable Length Coding)) or an arithmetic coding (e.g., CABAC (Context-based Adaptive Binary Arithmetic Coding)), is performed on the quantized transform coefficient. Thus, the transform coefficient is compressed. The resultant compressed image is accumulated in the accumulation buffer 67 and, subsequently, is output.

In addition, the quantized transform coefficient output from the quantizer unit 65 is also input to the inverse quantizer unit 68 and is inverse-quantized. Thereafter, the transform coefficient is further subjected to inverse orthogonal transformation in the inverse orthogonal transform unit 69. The output of the inverse orthogonal transformation is added to an inter predicted image or an intra predicted image supplied from the predicted image selecting unit 76 by the computing unit 70. In this way, a locally decoded image is generated. The de-blocking filter 71 removes block distortion of the locally decoded image and supplies the locally decoded image to the frame memory 72. Thus, the locally decoded image is accumulated. In addition, the image before the de-blocking filter process is performed by the de-blocking filter 71 is also supplied to the frame memory 72 and is accumulated.

The switch 73 outputs the image accumulated in the frame memory 72 to the motion prediction/compensation unit 75 or the intra prediction unit 74.

In the image encoding apparatus 51, for example, an I picture, a B picture, and a P picture received from the re-ordering screen buffer 62 are supplied to the intra prediction unit 74 as images to be subjected to intra prediction. In addition, a B picture and a P picture read from the re-ordering screen buffer 62 are supplied to the motion prediction/compensation unit 75 as images to be subjected to inter prediction.

The intra prediction unit 74 performs an intra prediction process in all of candidate intra prediction modes using the image to be subjected to intra prediction and read from the re-ordering screen buffer 62 and an image supplied from the frame memory 72 via the switch 73. Thus, the intra prediction unit 74 generates an intra predicted image.

Note that in the H.264/AVC coding standard, as an intra prediction mode for a luminance signal, a 4×4 pixel block based prediction mode, an 8×8 pixel block based prediction mode, and a 16×16 pixel block based prediction mode are defined. That is, macroblock based prediction modes are defined. In addition, an intra prediction mode for a color difference signal can be defined independently from the intra prediction mode for a luminance signal. The intra prediction mode for a color difference signal is defined on the basis of a macroblock.

In addition, the intra prediction unit 74 computes a cost function value for each of the all candidate intra prediction modes.

The cost function values is computed using one of the techniques of a High Complexity mode and a Low Complexity mode as defined in the JM (Joint Model), which is H.264/AVC reference software.

More specifically, when the High Complexity mode is employed as a technique for computing a cost function value, the processes up to the encoding process are temporarily performed for all of the candidate intra prediction modes. Thus, a cost function value defined by the following equation (2) is computed for each of the intra prediction modes.

Cost(Mode)=D+λ·R (2)

D denotes the difference (distortion) between the original image and the decoded image, R denotes an amount of generated code including up to the orthogonal transform coefficient, and λ denotes the Lagrange multiplier in the form of a function of a quantization parameter QP.

In contrast, when the Low Complexity mode is employed as a technique for computing a cost function value, generation of an intra predicted image and computation of header bits (e.g., information indicating the intra prediction mode) are performed for all of the candidate intra prediction modes. Thus, the cost function expressed in the following equation (3) is computed for each of the intra prediction modes.

Cost(Mode)=D+QPtoQuant(QP)·Header_Bit (3)

D denotes the difference (distortion) between the original image and the decoded image, Header_Bit denotes a header bit for the intra prediction mode, and QPtoQuant denotes a function provided in the form of a function of a quantization parameter QP.

In the Low Complexity mode, only an intra predicted image can be generated for each of all of the intra prediction modes. An encoding process needs not be performed. Accordingly, the amount of computation can be reduced.

The intra prediction unit 74 selects, as an optimal intra prediction mode, the intra prediction mode that provides a minimum value from among the cost function values computed in this manner. The intra prediction unit 74 supplies the intra predicted image generated in the optimal intra prediction mode and the cost function value thereof to the predicted image selecting unit 76. If the intra predicted image generated in the optimal intra prediction mode is selected by the predicted image selecting unit 76, the intra prediction unit 74 supplies information indicating the optimal intra prediction mode to the lossless encoding unit 66. The lossless encoding unit 66 lossless-encodes the information and uses the information as part of the header information.

The motion prediction/compensation unit 75 performs a motion prediction/compensation process for each of all of the candidate inter prediction modes. More specifically, the motion prediction/compensation unit 75 detects a motion vector in each of the candidate inter prediction modes on the basis of the image to be inter predicted read from the re-ordering screen buffer 62 and the image serving as a reference image supplied from the frame memory 72 via the switch 73. Thereafter, the motion prediction/compensation unit 75 performs the motion compensation process on the reference image on the basis of the motion vector and generates a motion compensated image.

Note that in the MPEG2 standard, the block size is fixed (16×16 pixel basis for an inter-frame motion prediction/compensation process and 16×8 pixel basis for each field in a inter-field prediction/compensation process), and a motion prediction/compensation process is performed. In contrast, in the H.264/AVC standard, the block size is variable, and a motion prediction/compensation process is performed.

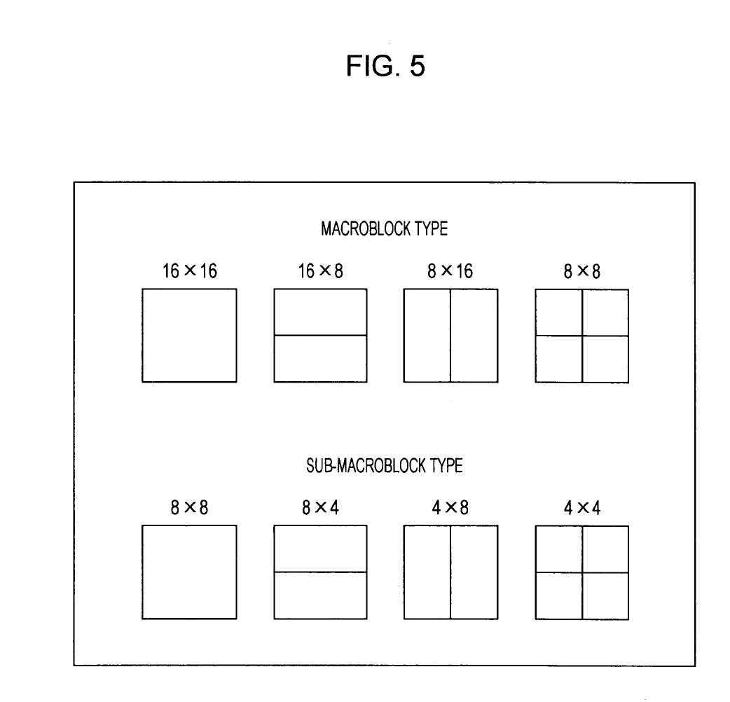

More specifically, as shown in FIG. 5, in the H.264/AVC standard, a macroblock including 16×16 pixels is separated into one of 16×16 pixel partitions, 16×8 pixel partitions, 8×16 pixel partitions, and 8×8 pixel partitions. Each of the partitions can have independent motion vector information. In addition, as shown in FIG. 5, an 8×8 pixel partition can be separated into one of 8×8 pixel sub-partitions, 8×4 pixel sub-partitions, 4×8 pixel sub-partitions, and 4×4 pixel sub-partitions. Each of the sub-partitions can have independent motion vector information.

Accordingly, the inter prediction mode includes eight types of mode for detecting a motion vector on one of a 16×16 pixel basis, a 16×8 pixel basis, an 8×16 pixel basis, an 8×8 pixel basis, an 8×4 pixel basis, a 4×8 pixel basis, and a 4×4 pixel basis.

Note that the motion prediction/compensation unit 75 may perform interpolation on an image to be inter predicted and the reference image and detect a motion vector with fractional-pel accuracy. Alternatively, the motion prediction/compensation unit 75 may detect a motion vector with integer-pel accuracy without performing interpolation.

In addition, the motion prediction/compensation unit 75 computes a cost function value for each of all of the candidate inter prediction modes using a technique that is the same as the technique employed by the intra prediction unit 74. The motion prediction/compensation unit 75 selects, as an optimal inter prediction mode, the prediction mode that minimizes the cost function value from among the computed cost function values.

Thereafter, the motion prediction/compensation unit 75 supplies the motion-compensated image generated in the optimal inter prediction mode to the predicted image selecting unit 76 as the inter predicted image. In addition, the motion prediction/compensation unit 75 supplies the cost function value of the optimal inter prediction mode to the predicted image selecting unit 76. When the inter predicted image generated in the optimal inter prediction mode is selected by the predicted image selecting unit 76, the motion prediction/compensation unit 75 outputs, to the lossless encoding unit 66, information indicating the optimal inter prediction mode and information associated with the optimal inter prediction mode (e.g., the motion vector information and the reference frame information). The lossless encoding unit 66 performs a lossless encoding process on the information received from the motion prediction/compensation unit 75 and inserts the information into the header portion of the compressed image.

The predicted image selecting unit 76 selects the optimal prediction mode from the optimal intra prediction mode and an optimal inter prediction mode on the basis of the cost function value output from the intra prediction unit 74 or the motion prediction/compensation unit 75. Thereafter, the predicted image selecting unit 76 selects one of the intra predicted image and the inter predicted image serving as a predicted image in the selected optimal prediction mode and supplies the selected predicted image to the computing units 63 and 70. At that time, the predicted image selecting unit 76 supplies information indicating that the intra predicted image has been selected to the intra prediction unit 74 or supplies information indicating that the inter predicted image has been selected to the motion prediction/compensation unit 75.

The rate control unit 77 controls the rate of the quantization operation performed by the quantizer unit 65 on the basis of the compressed images having a header portion and accumulated in the accumulation buffer 67 as compressed information so that overflow and underflow of the accumulation buffer 67 does not occur.

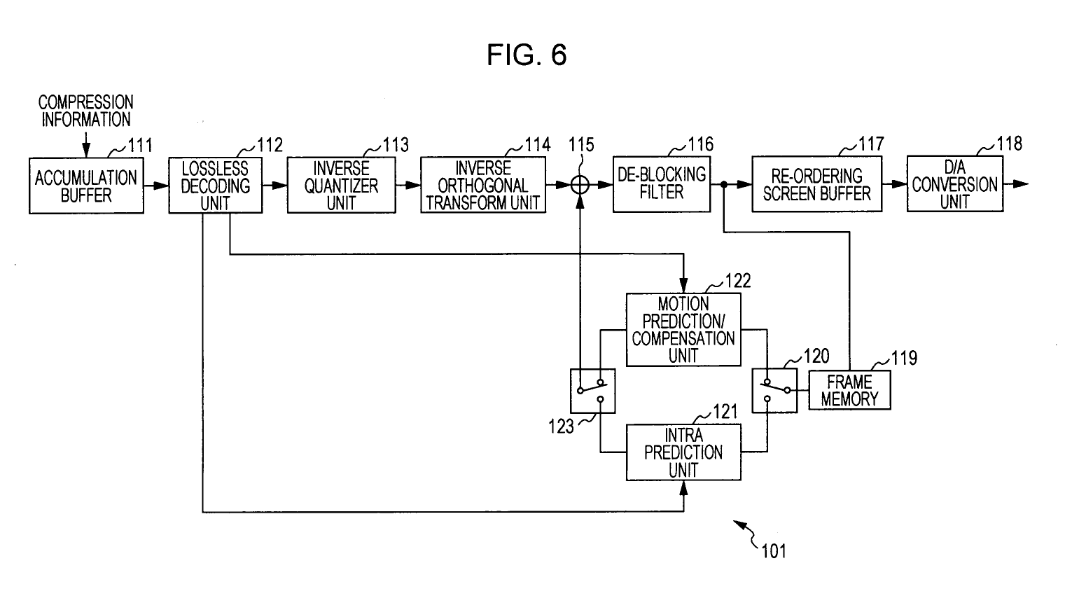

The compression information encoded by the image encoding apparatus 51 having the above-described configuration is transmitted via a predetermined transmission path and is decoded by the image decoding apparatus. FIG. 6 illustrates the configuration of such an image decoding apparatus.

An image decoding apparatus 101 includes an accumulation buffer 111, a lossless decoding unit 112, an inverse quantizer unit 113, an inverse orthogonal transform unit 114, a computing unit 115, a de-blocking filter 116, a re-ordering screen buffer 117, a D/A conversion unit 118, a frame memory 119, a switch 120, an intra prediction unit 121, a motion prediction/compensation unit 122, and a switch 123.

The accumulation buffer 111 accumulates transmitted compression information. The lossless decoding unit 112 lossless decodes (variable-length decodes or arithmetic decodes) the compression information lossless-encoded by the lossless encoding unit 66 shown in FIG. 4 and supplied from the accumulation buffer 111 using a method corresponding to the lossless encoding method employed by the lossless encoding unit 66. Thereafter, the lossless decoding unit 112 extracts, from information obtained through the lossless decoding, the image, the information indicating an optimal inter prediction mode or an optimal intra prediction mode, the motion vector information, and the reference frame information.

The inverse quantizer unit 113 inverse quantizes an image lossless-decoded by the lossless decoding unit 112 using a method corresponding to the quantizing method employed by the quantizer unit 65 shown in FIG. 4. Thereafter, the inverse quantizer unit 113 supplies the resultant transform coefficient to the inverse orthogonal transform unit 114. The inverse orthogonal transform unit 114 performs fourth-order inverse orthogonal transform on the transform coefficient received from the inverse quantizer unit 113 using a method corresponding to the orthogonal transform method employed by the orthogonal transform unit 64 shown in FIG. 4.

The inverse orthogonal transformed output is added to the intra predicted image or the inter predicted image supplied from the switch 123 and is decoded by the computing unit 115. The de-blocking filter 116 removes block distortion of the decoded image and supplies the resultant image to the frame memory 119. Thus, the image is accumulated. At the same time, the image is output to the re-ordering screen buffer 117.

The re-ordering screen buffer 117 re-orders images. That is, the order of frames that has been changed by the re-ordering screen buffer 62 shown in FIG. 4 for encoding is changed back to the original display order. The D/A conversion unit 118 D/A-converts an image supplied from the re-ordering screen buffer 117 and outputs the image to a display (not shown), which displays the image.

The switch 120 reads, from the frame memory 119, an image serving as a reference image in the inter prediction when the image is encoded. The switch 120 outputs the image to the motion prediction/compensation unit 122. In addition, the switch 120 reads an image used for intra prediction from the frame memory 119 and supplies the readout image to the intra prediction unit 121.

The intra prediction unit 121 receives, from the lossless decoding unit 112, information indicating an optimal intra prediction mode obtained by decoding the header information. When the information indicating an optimal intra prediction mode is supplied, the intra prediction unit 121 performs an intra prediction process in the intra prediction mode indicated by the information using the image received from the frame memory 119. Thus, the intra prediction unit 121 generates an intra predicted image. The intra prediction unit 121 outputs the generated intra predicted image to the switch 123.

The motion prediction/compensation unit 122 receives information obtained by lossless decoding the header information (e.g., the information indicating the optimal inter prediction mode, the motion vector information, and the reference image information) from the lossless decoding unit 112. Upon receiving the information indicating an optimal inter prediction mode, the motion prediction/compensation unit 122 performs a motion compensation process on the reference image received from the frame memory 119 in the optimal inter prediction mode indicated by the information using the motion vector information and the reference frame information supplied together with the information indicating an optimal inter prediction mode. Thus, the motion prediction/compensation unit 122 generates a motion-compensated image. Thereafter, the motion prediction/compensation unit 122 outputs the motion-compensated image to the switch 123 as the inter predicted image.

The switch 123 supplies, to the computing unit 115, the inter predicted image supplied from the motion prediction/compensation unit 122 or the intra predicted image supplied from the intra prediction unit 121.

### 2. Embodiment

### [Example of Configuration of Image Encoding Apparatus]

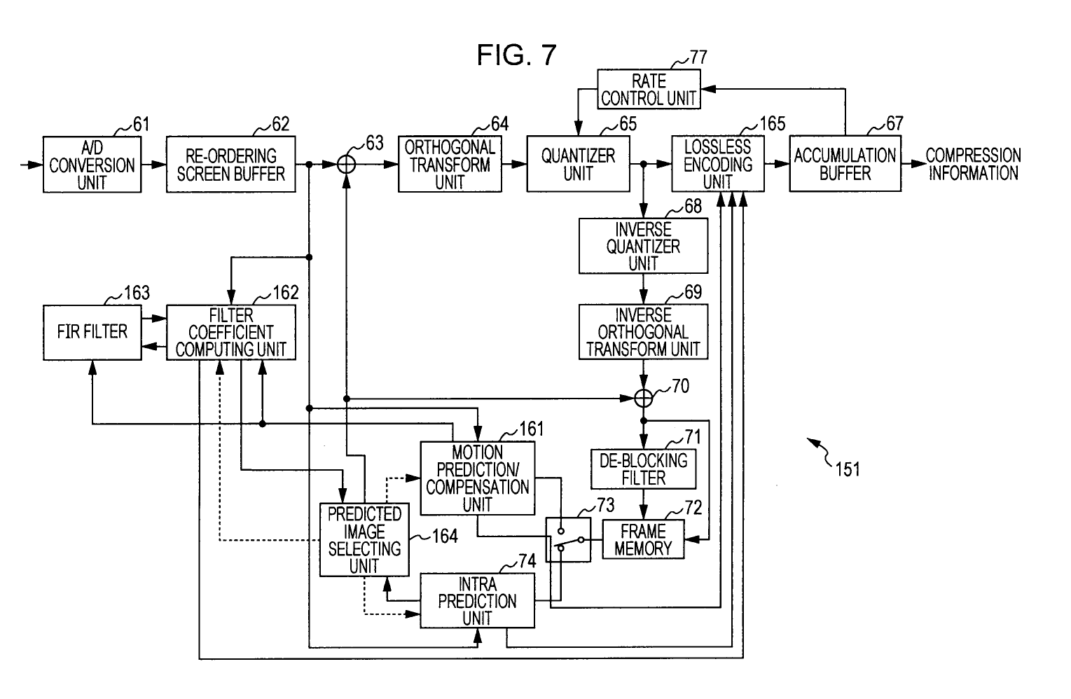

Next, FIG. 7 illustrates an example of the configuration of an image encoding apparatus according to an embodiment of the present invention.

The same numbering will be used in referring to the configuration in FIG. 7 as is utilized above in describing the configuration in FIG. 4. The same descriptions are not repeated.

The configuration of an image encoding apparatus 151 shown in FIG. 7 mainly differs from the configuration shown in FIG. 4 in that the image encoding apparatus 151 includes a motion prediction/compensation unit 161, a predicted image selecting unit 164, and a lossless encoding unit 165 in place of the motion prediction/compensation unit 75, the predicted image selecting unit 76, and the lossless encoding unit 66 and further includes a filter coefficient computing unit 162 and an FIR filter 163.

More specifically, like the motion prediction/compensation unit 75 shown in FIG. 4, the motion prediction/compensation unit 161 of the image encoding apparatus 151 shown in FIG. 7 performs a motion prediction/compensation process in all of the candidate inter prediction modes. In addition, like the motion prediction/compensation unit 75, the motion prediction/compensation unit 161 computes the cost function values for all of the candidate inter prediction modes and selects, as an optimal inter prediction mode, the inter prediction mode that provides a minimum value from among the computed cost function values.

Thereafter, the motion prediction/compensation unit 161 supplies a motion-compensated image generated in the optimal inter prediction mode to the filter coefficient computing unit 162 and the FIR filter 163. In addition, like the motion prediction/compensation unit 75, if the inter predicted image generated in the optimal inter prediction mode is selected by the predicted image selecting unit 164, the motion prediction/compensation unit 161 outputs, to the lossless encoding unit 165, information indicating the optimal inter prediction mode and information associated with the optimal inter prediction mode (e.g., the motion vector information and the reference frame information).

The filter coefficient computing unit 162 computes, using the motion compensated image supplied from the motion prediction/compensation unit 161 and the image to be inter predicted output from the re-ordering screen buffer 62 and used for the motion prediction/compensation process for the motion compensated image, a filter coefficient used for making the image filtered by the FIR filter 163 be similar to the image to be inter predicted. Thereafter, the filter coefficient computing unit 162 supplies the computed filter coefficient to the FIR filter 163.

In addition, the filter coefficient computing unit 162 computes the cost function value of the filtered image supplied from the FIR filter 163 using a method that is the same as that employed by the motion prediction/compensation unit 161. Thereafter, the filter coefficient computing unit 162 supplies the filtered image to the predicted image selecting unit 164 as an inter predicted image. In addition, the filter coefficient computing unit 162 supplies the cost function value of the inter predicted image to the predicted image selecting unit 164.

Furthermore, if the predicted image selecting unit 164 selects the inter predicted image generated in the optimal inter prediction mode, the filter coefficient computing unit 162 outputs the filter coefficient to the lossless encoding unit 165.

The FIR filter 163 performs a so-called convolution operation expressed by the following equation (4) on the motion-compensated image supplied from the motion prediction/compensation unit 161 using the filter coefficient supplied from the filter coefficient computing unit 162. In this way, the FIR filter 163 performs a filter process.

$$\begin{matrix}[ Math . 1 ] & \\ {o}_{( x , y )} = {\sum }_{kx = - Nx}^{+ Nx} {\sum }_{ky = - Ny}^{+ Ny} {h}_{( kx , ky )} {i}_{( x - kx , y - ky )} & ( 4 )\end{matrix}$$

In equation (4), o denotes the pixel value after the filter process is performed, i denotes the pixel value before the filter process is performed, that is, the pixel value after motion compensation is performed. Accordingly, may denote the pixel value with fractional pel accuracy or the pixel value with integer pel accuracy. In addition, x and y denote the positions of the pixel in the vertical direction and the horizontal direction, and h denotes the filter coefficient. The FIR filter 163 is characterized by the filter coefficient h. Note that the filter coefficient h is also referred to as an “impulse response”.

In addition, in equation (4), the FIR filter 163 is defined as a two-dimensional FIR filter having (2Nx+1)×(2Ny+1) taps. However, the number of taps is not limited to (2Nx+1)×(2Ny+1). Furthermore, in order to reduce the number of the filter coefficients h and the amount of computation, a one-dimensional FIR filter may be used as the FIR filter 163. In addition, instead of performing a two-dimensional convolution operation indicated by equation (4), the FIR filter 163 may perform a one-dimensional convolution operation twice in the vertical direction and the horizontal direction. In such a case, the number of the filter coefficients h and the amount of computation can be reduced. Furthermore, at that time, an area having a size larger than the motion compensation size is motion-compensated. Alternatively, if an insufficient area appears, the compensated pixel values are copied into the area.

The filtered image obtained in the above-described manner is supplied to the filter coefficient computing unit 162.

The predicted image selecting unit 164 selects the optimal prediction mode from the optimal intra prediction mode and an optimal inter prediction mode on the basis of the cost function values output from the intra prediction unit 74 or the filter coefficient computing unit 162. Thereafter, the predicted image selecting unit 164 selects one of the intra predicted image and the inter predicted image serving as a predicted image in the selected optimal prediction mode and supplies the selected predicted image to the computing units 63 and 70.

At that time, the predicted image selecting unit 164 supplies information indicating that the intra predicted image has been selected to the intra prediction unit 74 or supplies information indicating that the inter predicted image has been selected to the motion prediction/compensation unit 161 and the filter coefficient computing unit 162.

Like the lossless encoding unit 66, the lossless encoding unit 165 performs lossless encoding on the quantized transform coefficient supplied from the quantizer unit 65 and compresses the transform coefficient. Thus, the lossless encoding unit 165 generates a compressed image. In addition, the lossless encoding unit 165 performs lossless encoding on the information received from the intra prediction unit 74, the motion prediction/compensation unit 161, or the filter coefficient computing unit 162 and inserts the information into the header portion of the compressed image. Thereafter, the compressed image including the header portion generated by the lossless encoding unit 165 is accumulated in the accumulation buffer 67 as compression information and is subsequently output.

As described above, the image encoding apparatus 151 performs a filter process on the motion compensated image in inter prediction using the filter coefficient that makes the inter predicted image be similar to the image to be inter predicted. Accordingly, the difference between the inter predicted image and the image to be inter predicted can be reduced. As a result, the quality of the inter predicted image can be increased.

In addition, since the filter process is performed on the motion compensated image, the filter process, unlike existing AIFs, can be applied to the motion compensation process with integer pel accuracy. That is, even when the motion vector is provided for an integer position, a filter process can be performed. Therefore, even when a motion compensation process with integer pel accuracy is performed, the quality of an inter predicted image can be increased.

In addition, the difference between the inter predicted image and an image to be inter predicted deteriorates the subjective quality of the compressed image after decoding. However, in the image encoding apparatus 151, the difference is reduced. Therefore, the subjective quality of the compressed image after decoding can be improved.

Furthermore, when a filter process is performed in inter prediction, the filter coefficient needs to be transmitted to an image decoding apparatus (described below). Therefore, the bit length of the header portion of the compressed image is increased. However, as described above, the difference between the image to be inter predicted and the inter predicted image is reduced. As a result, the amount of data of the entire compression information, that is, the amount of code is reduced. Thus, the coding efficiency may be increased.

For example, when a two-dimensional filter having 5 taps is employed as the FIR filter 163, 25 (=5×5) filter coefficients are generated on a frame-by-frame basis. At that time, if each of the filter coefficients is represented using 12 bits, 300 (=25×12) bits need to be assigned as the bits of the filter coefficient for each of the frames. Accordingly, in such a case, if the amount of code of a compressed image can be reduced by more than or equal to 300 bits by performing the filter process, the amount of entire code of the compression information can be reduced.

### [Technique for Computing Filter Coefficient]

A technique for computing the filter coefficient in the filter coefficient computing unit 162 is described next.

A variety of techniques can be employed for computing the filter coefficient. In order to minimize the average of differences (the error) between a desired signal and a signal subjected to a filter process, it is desirable to compute the filter coefficient using the Wiener filter theory. Accordingly, the technique using the Wiener filter theory is described below.

Note that the term Wiener filter refers to a filter that minimizes the average of the squares of the differences between a desired signal and the filtered signal.

Here, let d be the pixel value of an image to be inter predicted serving as a desired signal, and o be the pixel value output from the FIR filter 163 and serving as a filtered signal. Then, a mean square error e, which is the average of the squares of the differences between the pixel values d and o is computed using the following equation (5). Note that for simplicity, in equation (5), the FIR filter 163 is a one-dimensional filter having (2N+1) taps.

$$\begin{matrix}[ Math . 2 ] & \\ \begin{matrix}e = E \{ {( d ( x , y ) - o ( x , y ) )}^{2} \} \\ = E \{ {( d ( x , y ) - {\sum }_{kx = - Nx}^{+ Nx} {\sum }_{ky = - Ny}^{+ Ny} {h}_{( kx , ky )} {i}_{( x - kx , y - ky )} )}^{2} \}\end{matrix} & ( 5 )\end{matrix}$$

In equation (5), E{ } represents the expected value of a value in parentheses. In addition, i denotes the pixel value before the filter process is performed, that is, the pixel value after motion compensation is performed. Accordingly, i may denote the pixel value with fractional pel accuracy or the pixel value with integer pel accuracy. x and y denote the position of the pixel in the vertical direction and the horizontal direction, and h denotes the filter coefficient.

The design of the Wiener filter boils down to a problem of computing the filter coefficient h that minimizes the mean square error e. Accordingly, using a least square method, the filter coefficient computing unit 162 can partially differentiate the mean square error e with respect to the filter coefficient h and compute the filter coefficient h by setting the answer to 0.

More specifically, by partially differentiating the mean square error e with respect to the filter coefficient h, the following equation (6) can be obtained.

$$\begin{matrix}[ Math . 3 ] & \\ \begin{matrix}\frac{\partial e}{\partial h ( mx , my )} = \frac{\partial }{\partial h ( mx , my )} E \{ {( d ( x , y ) - o ( x , y ) )}^{2} \} \\ = E \{ \frac{\partial }{\partial h ( mx , my )} {( \begin{matrix}d ( x , y ) - {\sum }_{kx = - Nx}^{+ Nx} {\sum }_{ky = - Ny}^{Ny} \\ {h}_{( kx , ky )} {i}_{( x - kx , y - ky )}\end{matrix} )}^{2} \} \\ = - 2 [ \begin{matrix}E \{ {d}_{( x , y )} {i}_{( nx - mx , ny - my )} \} - \\ {\sum }_{kx = - Nx}^{+ Nx} {\sum }_{ky = - Ny}^{Ny} {h}_{( kx , ky )} E \{ {i}_{( x - kx , y - ky )} {i}_{( x - mx , y - my )} \}\end{matrix} ]\end{matrix} \\ mx = - Nx , … , - 2 , - 1 , 0 , 1 , 2 , … , + Nx \\ my = - Ny , … , - 2 , - 1 , 0 , 1 , 2 , … , + Ny & ( 6 )\end{matrix}$$

Then, the equation (6) is set to 0, and the equation is rearranged. Thus, the following equation (7) can be obtained.

$$\begin{matrix} [ Math . 4 ] & \\ E \{ {d}_{( x , y )} {i}_{( x - mx , y - my )} \} = {\sum }_{kx = - Nx}^{+ Nx} {\sum }_{ky = - Ny}^{Ny} {h}_{( kx , ky )}^{OP} \{ {i}_{( x - kx , y - k )} {i}_{( x - mx , y - my )} \} \\ mx = - Nx , … , - 2 , - 1 , 0 , 1 , 2 , … , + Nx \\ my = - Ny , … , - 2 , - 1 , 0 , 1 , 2 , … , + Ny & ( 7 )\end{matrix}$$

Therefore, by computing h in equation (7), the filter coefficient that minimizes the mean square error e can be obtained. More specifically, since equation (7) represents a simultaneous equation, the filter coefficient can be computed by solving the simultaneous equation.

Accordingly, the filter coefficient computing unit 162 computes a correlation between the pixel value d of the image to be inter predicted and the pixel value i of the motion compensated image and the autocorrelation of the pixel value i of the motion compensated image and solves the simultaneous equation in equation (7). In this way, the filter coefficient computing unit 162 computes the filter coefficient h. [Description of Encoding Process]

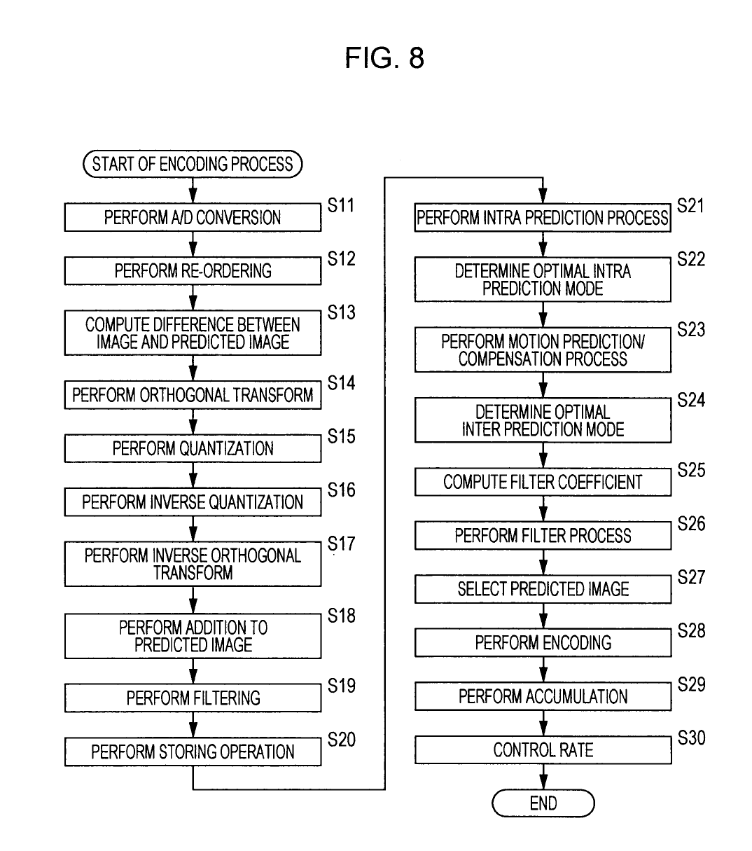

The encoding process performed by the image encoding apparatus 151 shown in FIG. 7 is described next with reference to a flowchart shown in FIG. 8.

In step S11, the A/D conversion unit 61 A/D-converts an input image. In step S12, the re-ordering screen buffer 62 stores the image supplied from the A/D conversion unit 61 and converts the order in which pictures are displayed into the order in which the pictures are to be encoded.

In step S13, the computing unit 63 computes the difference between the image re-ordered in step S12 and the intra predicted image or the inter predicted image received from the predicted image selecting unit 164.

The data size of the difference data is smaller than that of the original image data. Accordingly, the data size can be reduced by computing the difference data and encoding the difference data, as compared with the case in which the image is directly encoded.

In step S14, the orthogonal transform unit 64 performs orthogonal transform on the difference supplied from the computing unit 63. More specifically, orthogonal transform, such as discrete cosine transform or Karhunen-Loeve transform, is performed, and a transform coefficient is output. In step S15, the quantizer unit 65 quantizes the transform coefficient. As described in more detail below with reference to a process performed in step S30, the rate is controlled in this quantization process.

The difference quantized in the above-described manner is locally decoded as follows. That is, in step S16, the inverse quantizer unit 68 inverse quantizes the transform coefficient quantized by the quantizer unit 65 using a characteristic that is the reverse of the characteristic of the quantizer unit 65. In step S17, the inverse orthogonal transform unit 69 performs inverse orthogonal transform on the transform coefficient inverse quantized by the inverse quantizer unit 68 using the characteristic corresponding to the characteristic of the orthogonal transform unit 64.

In step S18, the computing unit 70 adds the inter predicted image or the intra predicted image input via the predicted image selecting unit 164 to the locally decoded difference. Thus, the computing unit 70 generates a locally decoded image (an image corresponding to the input of the computing unit 63). In step S19, the de-blocking filter 71 performs a filter process on the image output from the computing unit 70. In this way, block distortion is removed. In step S20, the frame memory 72 stores the filtered image. Note that the image that is not subjected to the filter process performed by the de-blocking filter 71 is also supplied from the computing unit 70 and is stored in the frame memory 72.

In step S21, the intra prediction unit 74 performs the image prediction process in all the candidate intra prediction modes on the basis of the image to be intra predicted read from the re-ordering screen buffer 62 and the image supplied from the frame memory 72 via the switch 73. Thus, the intra prediction unit 74 generates intra predicted images. Thereafter, the intra prediction unit 74 computes the cost function values for all the candidate intra prediction modes.

In step S22, the intra prediction unit 74 selects, as an optimal intra prediction mode, the intra prediction mode that provides a minimum value from among the computed cost function values. Thereafter, the intra prediction unit 74 supplies the intra predicted image generated in the optimal intra prediction mode and the cost function value thereof to the predicted image selecting unit 164.

In step S23, the motion prediction/compensation unit 161 performs a motion prediction/compensation process in all the candidate inter prediction modes on the basis of the image to be inter predicted read from the re-ordering screen buffer 62 and the image serving as the reference image supplied from the frame memory 72 via the switch 73. Thereafter, the motion prediction/compensation unit 161 computes the cost function values for all of the candidate inter prediction modes.

In step S24, the motion prediction/compensation unit 161 selects, as an optimal inter prediction mode, the inter prediction mode that provides a minimum value among the computed cost function values. Thereafter, the motion prediction/compensation unit 161 supplies a motion-compensated image generated in the optimal inter prediction mode to the filter coefficient computing unit 162.

In step S25, the filter coefficient computing unit 162 computes the filter coefficient h. More specifically, the filter coefficient computing unit 162 computes the above-described equation (7) using the motion compensated image received from the motion prediction/compensation unit 161 and the image to be inter predicted that was used for the motion prediction/compensation process of the motion compensated image and output from the re-ordering screen buffer 62. Thereafter, the filter coefficient computing unit 162 supplies the computed filter coefficient h to the FIR filter 163.

In step S26, the FIR filter 163 performs a filter process on the motion compensated image received from the motion prediction/compensation unit 161 by performing computation indicated by the above-described equation (4) using the filter coefficient received from the filter coefficient computing unit 162. Thereafter, the FIR filter 163 supplies the filtered image to the filter coefficient computing unit 162.

As a result, the filter coefficient computing unit 162 computes the cost function value of the filtered image using a technique that is the same as that used by the motion prediction/compensation unit 161. Thereafter, the filter coefficient computing unit 162 supplies the filtered image to the predicted image selecting unit 164 as the inter predicted image. In addition, the filter coefficient computing unit 162 supplies the cost function value of the inter predicted image to the predicted image selecting unit 164.

In step S27, the predicted image selecting unit 164 selects one of the optimal intra prediction mode and the optimal inter prediction mode as the optimal prediction mode using the cost function values output from the intra prediction unit 74 and the filter coefficient computing unit 162. Thereafter, the predicted image selecting unit 164 selects the predicted image of the selected optimal prediction mode. In this way, the inter predicted image or the intra predicted image selected as a predicted image of the optimal prediction mode is supplied to the computing units 63 and 70 and is used for the computation performed in steps S13 and S18.

Note that at that time, the predicted image selecting unit 164 supplies selection information to the intra prediction unit 74 or both of the motion prediction/compensation unit 161 and the filter coefficient computing unit 162. If the selection information indicating that the intra predicted image has been selected is supplied, the intra prediction unit 74 supplies information indicating the optimum intra prediction mode to the lossless encoding unit 165.

If the selection information indicating that the optimal inter prediction mode has been selected is supplied, the motion prediction/compensation unit 161 outputs the information indicating the optimal inter prediction mode, the motion vector information, and the reference frame information to the lossless encoding unit 165. The filter coefficient computing unit 162 outputs the filter coefficient to the lossless encoding unit 165.

In step S28, the lossless encoding unit 165 encodes the quantized transform coefficient output from the quantizer unit 65 and generates a compressed image. At that time, information indicating the optimal intra prediction mode or the optimal inter prediction mode, the information associated with the optimal inter prediction mode (e.g., the motion vector information and the reference frame information), and the filter coefficient are also lossless-encoded and are inserted into the header portion of the compressed image.

In step S29, the accumulation buffer 67 accumulates the compressed image including the header portion generated by the lossless encoding unit 165 as compression information. The compression information accumulated in the accumulation buffer 67 is read out as needed and is transmitted to the image decoding apparatus via a transmission path.

In step S30, the rate control unit 77 controls the rate of the quantization operation performed by the quantizer unit 65 on the basis of the compression information accumulated in the accumulation buffer 67 so that overflow or underflow of the accumulation buffer 67 does not occur.

In the above description, the image encoding apparatus 151 determines the optimal inter prediction mode on the basis of the cost function value of the motion compensated image and performs a filter process on the motion compensated image in the optimal inter prediction mode. However, the filter process may be performed on the motion compensated images in all of the candidate inter prediction modes, and the optimal inter prediction mode may be determined on the basis of the cost function values of the resultant images.

The compression information encoded by the image encoding apparatus 151 in this manner is transmitted via a predetermined transmission path and is decoded by the image decoding apparatus.

[Example of Detailed Configuration around Filter Coefficient Computing Unit and FIR Filter]

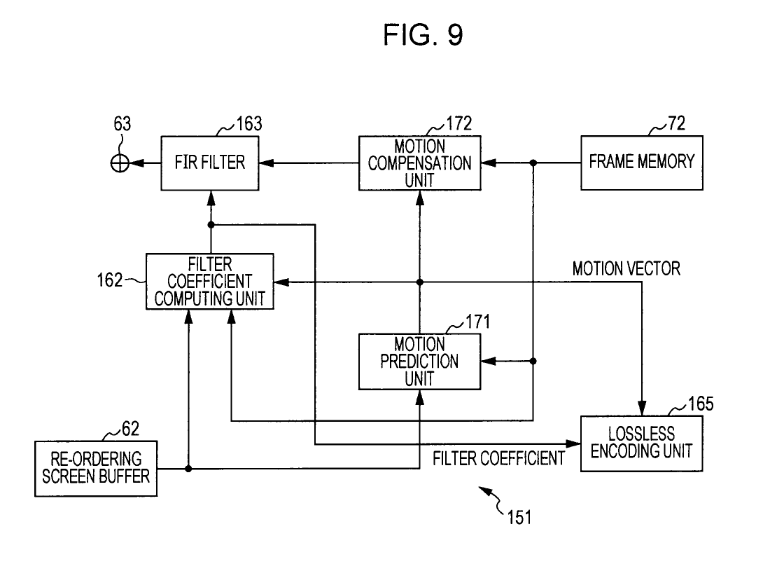

FIG. 9 illustrates an example of the detailed configuration around the filter coefficient computing unit and the FIR filter in the image encoding apparatus 151 shown in FIG. 7.

Note that in the example shown in FIG. 9, the motion prediction/compensation unit 161 is functionally separated into a motion prediction unit 171 and a motion compensation unit 172. In addition, in the example shown in FIG. 9, for simplicity and ease of understanding of the advantages, the switch 73, the intra prediction unit 74, and the predicted image selecting unit 164 are not shown even in the vicinity. Furthermore, the cost function value is not computed, and a predicted image is not selected. An image motion-predicted and compensated in some inter predicted mode using the reference image received from the frame memory 72 is output to the computing unit 63.

The motion prediction unit 171 performs a motion prediction process in the motion prediction/compensation unit 161. That is, the motion prediction unit 171 detects a motion vector in an inter prediction mode on the basis of an image to be inter predicted read from the re-ordering screen buffer 62 and an image supplied from the frame memory 72 and serving as the reference image. The motion vector detected by the motion prediction unit 171 is output to the motion compensation unit 172, the filter coefficient computing unit 162, and the lossless encoding unit 165. The lossless encoding unit 165 lossless-encodes the information and uses the encoded information as part of the header of the compressed image.

The motion compensation unit 172 performs a motion compensation process in the motion prediction/compensation unit 161. That is, the motion compensation unit 172 performs a motion compensation process on the reference image supplied from the frame memory 72 using the motion vector supplied from the motion prediction unit 171. Thus, the motion compensation unit 172 generates a motion compensated image and outputs the motion compensated image to the FIR filter 163. Note that at that time, in order to compensate an area larger than the motion compensation size in accordance with the number of the filter taps, the area having that size is acquired from the frame memory 72.

The filter coefficient computing unit 162 computes the filter coefficient used for making the image filtered by the FIR filter 163 (i.e., the motion compensated image) be similar to the image to be inter predicted using the image to be inter predicted output from the FIR filter 163 using the motion vector supplied from the motion prediction unit 171, the reference image supplied from the frame memory 72, and the image to be inter predicted that was used for the motion prediction process and output from the re-ordering screen buffer 62. Thereafter, the filter coefficient computing unit 162 supplies the computed filter coefficient to the FIR filter 163 and the lossless encoding unit 165.

Note that like the image encoding apparatus 151 shown in FIG. 7, the filter coefficient computing unit 162 may use the motion compensated image supplied from the motion compensation unit 172 instead of using the motion vector supplied from the motion prediction unit 171 and the reference image supplied from the frame memory 72.

The FIR filter 163 performs a so-called convolution operation expressed by the above-described equation (4) on the motion compensated image supplied from the motion compensation unit 172 using the filter coefficient supplied from the filter coefficient computing unit 162. In this way, the FIR filter 163 performs a filter process. The filtered motion-compensated image is output to the computing unit 63, and a difference between the image and the image to be encoded is computed. The difference between the image to be encoded and the filtered motion-compensated image is encoded in the lossless encoding unit 165 via the orthogonal transform unit 64 and the quantizer unit 65. The encoded difference is transmitted to the decoding side.

As described above, in the image encoding apparatus 151 shown in FIG. 9, a filter process is performed on the motion compensated image.

The AIF described in NPL 1 is described next. An AIF can reduce encoding distortion. However, since an AIF is a filter for a filter for performing interpolation, the AIF cannot be applied to the case of a motion vector with integer pel accuracy, although the AIF is effective for the case of a motion vector with fractional pel accuracy. In addition, since an AIF is a filter for performing interpolation, the filter coefficients for all of the pixels of integer-pel accuracy need to be transmitted to the decoding side.

In contrast, in the image encoding apparatus 151, a filter process is performed on the motion compensated image. That is, the filter process is also applied to the motion compensation process with integer-pel accuracy. Accordingly, even when the motion vector is provided for an integer position, a filter process can be applied. Therefore, even when a motion compensation process with integer pel accuracy is performed, the quality of an inter predicted image can be increased.

In addition, since the need for the filter coefficients for the pixels of fractional-pel accuracy can be eliminated, the overhead of transmitting the filter coefficients can be reduced.

Furthermore, the ALF described in NPL 3 is described next. An ALF is a filter for making the current input be similar to the output of the de-blocking filter 71 (i.e., the output after the residual error is reconfigured). Therefore, the ALF does not have an effect to reduce the current residual error. For example, the ALF is advantageous when the next slice is P or P continuously appears.

In contrast, in the image encoding apparatus 151, a filter process is performed so that the output of the FIR filter 163 (i.e., the residual error, which is the output of the computing unit 63, as a result) is reduced. Therefore, since the current residual error can be reduced, the bit length of residual information can be reduced.

Note that while the above description has been made with reference to the example in which a filter process is performed on a motion compensated image, an example in which a filter process is performed on an image to be motion compensated, that is, the reference image and, thereafter, motion compensation is performed on the image is described below.

### [Another Example of Detailed Configuration Around Filter Coefficient Computing Unit and FIR Filter]

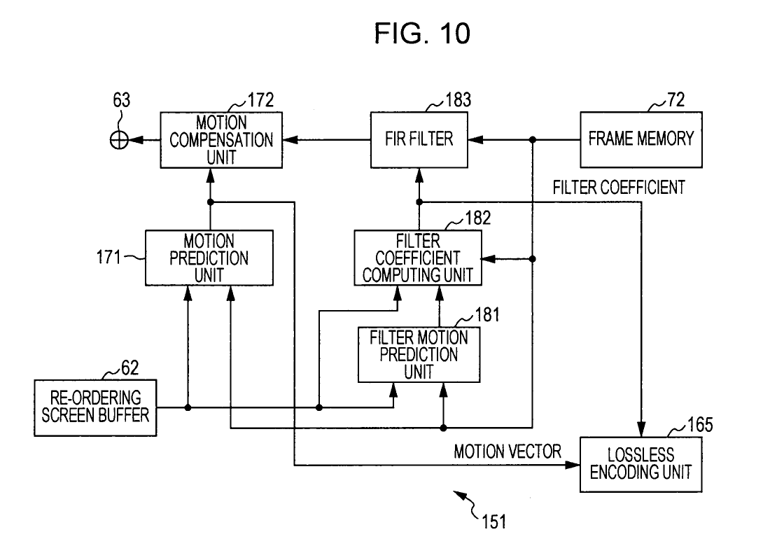

FIG. 10 illustrates an example of the detailed configuration around the filter coefficient computing unit and the FIR filter in the image encoding apparatus 151 shown in FIG. 7.

Note that like the example illustrated in FIG. 9, in the example illustrated in FIG. 10, the motion prediction/compensation unit 161 is functionally separated into the motion prediction unit 171 and the motion compensation unit 172. In addition, unlike the example illustrated in FIG. 9, a filter motion prediction unit 181 is additionally provided, and a filter coefficient computing unit 182 and the FIR filter 183 are provided in place of the filter coefficient computing unit 161 and the FIR filter 162, respectively. Furthermore, like the example illustrated in FIG. 9, in the example illustrated in FIG. 10, for simplicity and ease of understanding of the advantages, the switch 73, the intra prediction unit 74, and the predicted image selecting unit 164 are not shown even in the vicinity. The cost function value is not computed, and a predicted image is not selected. An image that is motion-predicted and compensated in some inter predicted mode using the reference image received from the frame memory 72 is output to the computing unit 63.

The filter motion prediction unit 181 detects a motion vector used in the filter coefficient computing unit 182 before the motion prediction unit 171 performs motion prediction. That is, the filter motion prediction unit 181 detects a motion vector for filtering on the basis of the image to be inter predicted read from the re-ordering screen buffer 62 and the image supplied from the frame memory 72 and serving as the reference image. The detected motion vector is output to the filter coefficient computing unit 182.

Note that the filter motion prediction unit 181 and the motion prediction unit 171 can be shared with each other.

The filter coefficient computing unit 182 computes the filter coefficient used for making the reference image filtered by the FIR filter 183 (i.e., the reference image) be similar to the image to be inter predicted using the motion vector supplied from the filter motion prediction unit 181, the reference image supplied from the frame memory 72, and the image to be inter predicted output from the re-ordering screen buffer 62 and used for the motion prediction process. Thereafter, the filter coefficient computing unit 182 supplies the computed filter coefficient to the FIR filter 183 and the lossless encoding unit 165.

The FIR filter 183 performs a so-called convolution operation expressed by the above-described equation (4) on the reference image supplied from the frame memory 72 using the filter coefficient supplied from the filter coefficient computing unit 182. In this way, the FIR filter 183 performs a filter process. The reference image subjected to the filter process is output to the motion compensation unit 172. Note that at that time, an area larger than the motion compensation size is acquired from the frame memory 72 in accordance with the number of the filter taps.

Like the example illustrated in FIG. 9, the motion prediction unit 171 detects a motion vector in an inter prediction mode on the basis of the image to be inter predicted read from the re-ordering screen buffer 62 and the image supplied from the frame memory 72 and serving as a reference image. The motion vector detected by the motion prediction unit 171 is output to the motion compensation unit 172 and the lossless encoding unit 165.

The motion compensation unit 172 performs a motion compensation process on the filtered reference image supplied from the FIR filter 183 using the motion vector supplied from the motion prediction unit 171 and generates a motion compensated image. The motion compensated image is output to the computing unit 63, and a difference between the motion compensated image and the image to be encoded is computed. The difference between the image to be encoded and the filtered motion-compensated image is encoded by the lossless encoding unit 165 via the orthogonal transform unit 64 and the quantizer unit 65. Thereafter, the difference is transmitted to the decoding side.

As described above, in the image encoding apparatus 151 shown in FIG. 10, a filter process is performed on a reference image before motion compensation is performed on the reference image. That is, the filter process is performed on the pixels of a reference image with integer pel accuracy. Accordingly, even when the motion vector is provided for an integer position, a filter process is performed. Therefore, even when a motion compensation process with integer pel accuracy is performed, the quality of an inter predicted image can be increased.

In addition, even in the case illustrated in FIG. 10, the need for the filter coefficients for the pixels of fractional-pel accuracy are not needed. Thus, the overhead of transmitting the filter coefficients can be reduced.

Furthermore, even in the case illustrated in FIG. 10, a filter process is performed in the image encoding apparatus 151 so that the output of the FIR filter 183 is reduced. As a result, since the residual error, which is the output of the computing unit 63, can be reduced, the bit length of residual information can be reduced.

As described above, even when the order in which the motion prediction process, the motion compensation process, and the FIR filter are performed is changed, the same advantage can be provided.

### [Example of Configuration of Image Decoding Apparatus]

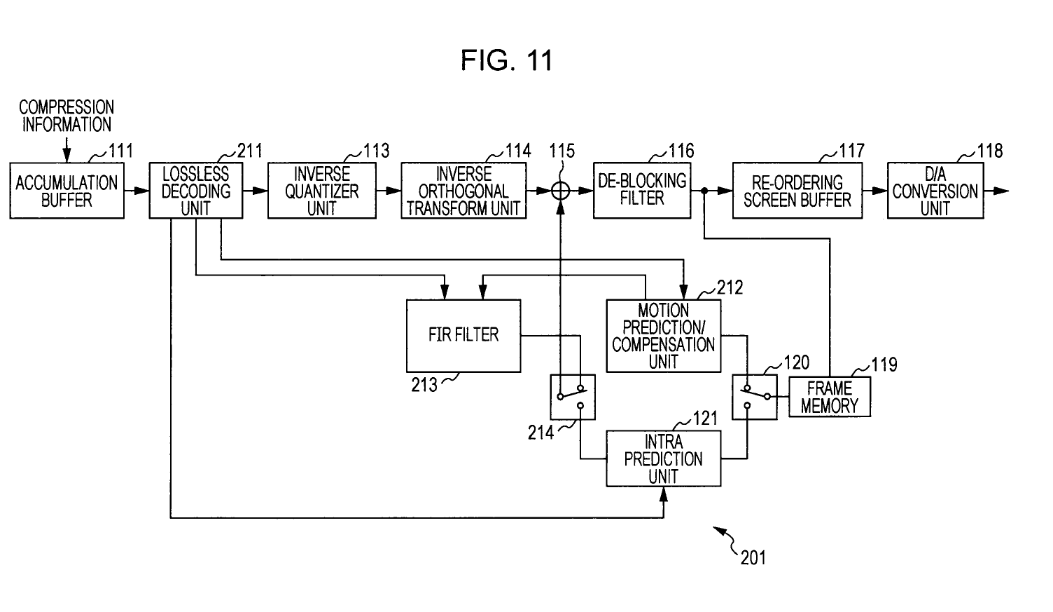

FIG. 11 illustrates an example of the configuration of such an image decoding apparatus.

The same numbering will be used in referring to the configuration in FIG. 11 as is utilized above in describing the configuration in FIG. 6. The same descriptions are not repeated as needed.

As shown in FIG. 11, the configuration of an image decoding apparatus 201 mainly differs from that shown in FIG. 6 in that a lossless decoding unit 211, a motion prediction/compensation unit 212, and a switch 214 are provided in place of the lossless decoding unit 112, the motion prediction/compensation unit 122, and the switch 123, respectively, and an FIR filter 213 is additionally provided.

More specifically, the lossless decoding unit 211 of the image decoding apparatus 201 shown in FIG. 11 lossless decodes the compression information lossless-encoded by the lossless encoding unit 165 shown in FIG. 7 and supplied from the accumulation buffer 111 using a method corresponding to the lossless encoding method employed by the lossless encoding unit 165. Thereafter, the lossless decoding unit 211 extracts, from information obtained through the lossless decoding, the image, the information indicating an optimal inter prediction mode or an optimal intra prediction mode, the motion vector information, and the reference frame information, and the filter coefficient h.

Like the motion prediction/compensation unit 122 shown in FIG. 6, the motion prediction/compensation unit 212 receives information obtained by lossless decoding the header information (e.g., the information indicating the optimal inter prediction mode, the motion vector information, and the reference image information) from the lossless decoding unit 211. Like the motion prediction/compensation unit 122, upon receiving the information indicating an optimal inter prediction mode, the motion prediction/compensation unit 212 performs a motion compensation process on the reference image received from the frame memory 119 in the optimal inter prediction mode indicated by the information using the motion vector information and the reference frame information supplied together with the information indicating an optimal inter prediction mode. Thereafter, the motion prediction/compensation unit 212 outputs the resultant motion-compensated image to the FIR filter 213.

The FIR filter 213 receives, from the lossless decoding unit 211, the filter coefficient h obtained by lossless decoding the header portion. The FIR filter 213 performs a filter process on the motion compensated image received from the motion prediction/compensation unit 212 by performing computation indicated by the above-described equation (4) using the filter coefficient h. Thereafter, the FIR filter 213 outputs the filtered image to the switch 214 as an inter predicted image.

The switch 214 supplies the inter predicted image supplied from the FIR filter 213 or the intra predicted image supplied from the intra prediction unit 121 to the computing unit 115.

As described above, the image decoding apparatus 201 performs a filter process on the motion-compensated image in inter prediction using the filter coefficient h that is transmitted from the image encoding apparatus 151 and that makes the inter predicted image be similar to the image to be inter predicted. Therefore, inter prediction can be performed more accurately, and the quality of the inter predicted image can be increased.

In addition, since a filter process is performed on the motion-compensated image, a filter process is performed even when the motion vector is provided for an integer position. Therefore, even when a motion compensation process with integer pel accuracy is performed, the quality of an inter predicted image can be increased.

### [Description of Decoding Process]

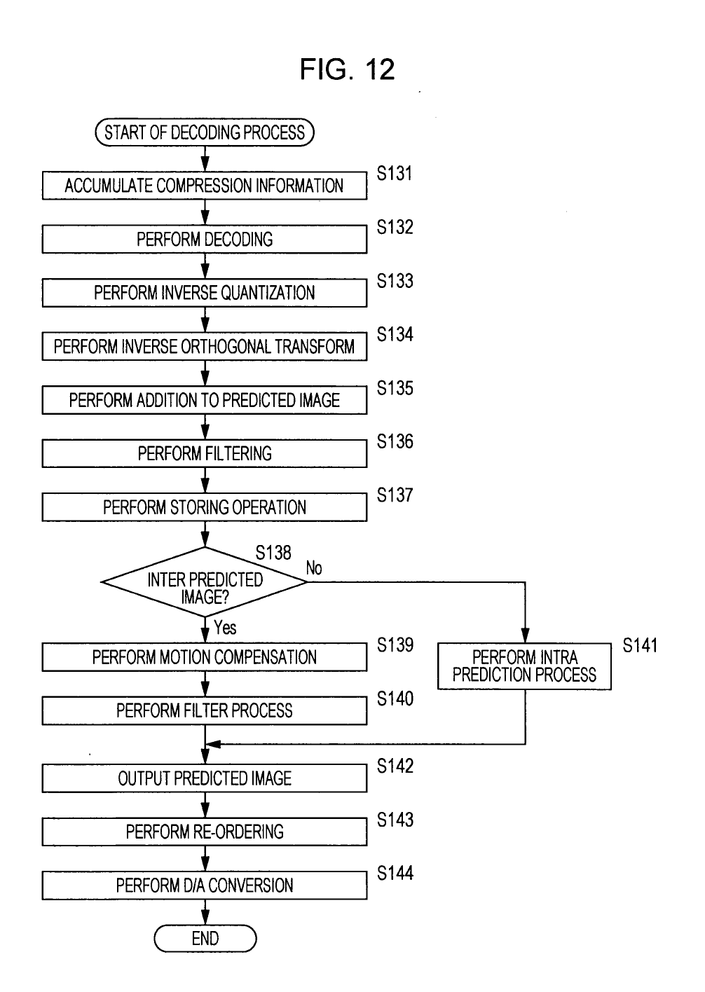

The decoding process performed by the image decoding apparatus 201 shown in FIG. 11 is described with reference to a flowchart shown in FIG. 12.

In step S131, the accumulation buffer 111 accumulates transmitted compression information. In step S132, the lossless decoding unit 211 lossless decodes the compression information supplied from the accumulation buffer 111. That is, the I picture, the P picture, and the B picture lossless-encoded by the lossless encoding unit 165 shown in FIG. 7 are lossless decoded. Note that at that time, the motion vector information, the reference frame information, the information indicating an optimal intra prediction mode or an optimal inter prediction mode, and the filter coefficient are also decoded.

In step S133, the inverse quantizer unit 113 inverse quantizes the transform coefficient lossless decoded by the lossless decoding unit 211 using a characteristic corresponding to the characteristic of the quantizer unit 65 shown in FIG. 7. In step S134, the inverse orthogonal transform unit 114 performs inverse orthogonal transform on the transform coefficient inverse quantized by the inverse quantizer unit 113 using a characteristic corresponding to the characteristic of the orthogonal transform unit 64 shown in FIG. 7. In this way, the difference serving as the input of the orthogonal transform unit 64 shown in FIG. 7 (the output of the computing unit 63) is decoded.

In step S135, the computing unit 115 adds the decoded difference to the inter predicted image or the intra predicted image output from the switch 214 through the processing performed in step S142 described below. Thus, an original image is decoded. In step S136, the de-blocking filter 116 filters the image output from the computing unit 115. In this way, block distortion can be removed. In step S137, the frame memory 119 stores the filtered image.

In step S138, the lossless decoding unit 211 determines whether the compressed image is an inter predicted image, that is, whether information indicating the optimal inter prediction mode is included in the lossless decoding result on the basis of the lossless decoded result of the header portion of the compressed image.

If, in step S138, it is determined that the compressed image is an inter predicted image, the lossless decoding unit 211 supplies the motion vector information, the reference frame information, and the information indicating the optimal inter prediction mode to the motion prediction/compensation unit 212. In addition, the lossless decoding unit 211 supplies the filter coefficient to the FIR filter 213.

Subsequently, in step S139, the motion prediction/compensation unit 212 performs a motion compensation process on the reference image supplied from the frame memory 119 in the optimal inter prediction mode indicated by the information received from the lossless decoding unit 211 on the basis of the motion vector information and the reference frame information indicated by the information received from the lossless decoding unit 211. Thereafter, the motion prediction/compensation unit 212 outputs the resultant motion-compensated image to the FIR filter 213.

In step S140, the FIR filter 213 performs a filter process on the motion compensated image supplied from the motion prediction/compensation unit 212 by performing computation indicated by the above-described equation (4) using the filter coefficient received from the lossless decoding unit 211.

However, if, in step S138, it is determined that the compressed image is not an inter predicted image, that is, if information indicating the optimal intra prediction mode is included in the lossless decoding result, the lossless decoding unit 211 supplies the information indicating the optimal intra prediction mode to the intra prediction unit 121. Subsequently, in step S141, the intra prediction unit 121 performs an intra prediction process on the image supplied from the frame memory 119 in the optimal intra prediction mode indicated by the information received from the lossless decoding unit 211 and generates an intra predicted image. Thereafter, the intra prediction unit 121 outputs the intra predicted image to the switch 214.

After the process performed in step S140 or S141 is completed, the switch 214, in step S142, outputs the inter predicted image supplied from the FIR filter 213 or the intra predicted image supplied from the intra prediction unit 121 to the computing unit 115. In this way, as described above, in step S135, the inter predicted image or the intra predicted image is added to the output of the inverse orthogonal transform unit 114.

In step S143, the re-ordering screen buffer 117 re-orders images. That is, the order of frames that has been changed by the re-ordering screen buffer 62 of the image encoding apparatus 151 for encoding is changed back to the original order for displaying.

In step S144, the D/A conversion unit 118 D/A-converts an image supplied from the re-ordering screen buffer 117. The image is output to a display (not shown), which displays the image.

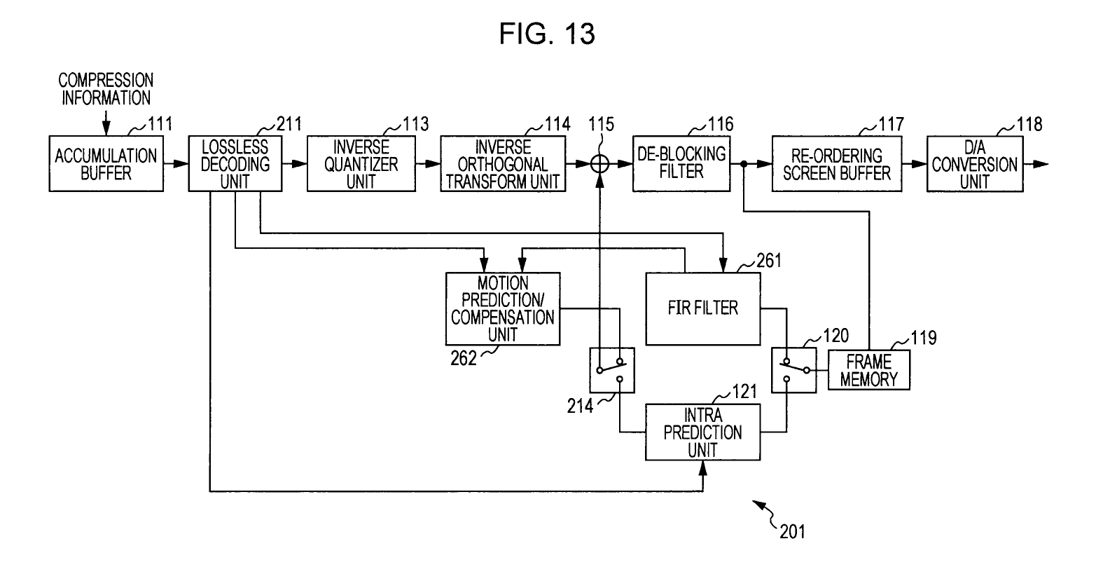

Note that FIG. 11 illustrates an example of the image decoding apparatus 201 that corresponds to the above-described image encoding apparatus 151 shown in FIGS. 7 and 9. As described below, the image decoding apparatus 201 that corresponds to the image encoding apparatus 151 shown in FIG. 10 is configured as shown in FIG. 13.

The image decoding apparatus 201 shown in FIG. 13 is similar to the image decoding apparatus 201 shown in FIG. 11 in that the image decoding apparatus 201 includes the accumulation buffer 111, the lossless decoding unit 211, the inverse quantizer unit 113, the inverse orthogonal transform unit 114, the computing unit 115, the de-blocking filter 116, the re-ordering screen buffer 117, the D/A conversion unit 118, the frame memory 119, the switch 120, the intra prediction unit 121, and the switch 214. However, the image decoding apparatus 201 shown in FIG. 13 differs from the image decoding apparatus 201 shown in FIG. 11 in that the motion prediction/compensation unit 212 and the FIR filter 213 are replaced by a motion prediction/compensation unit 262 and an FIR filter 261, respectively.

That is, the image decoding apparatus 201 shown in FIG. 13 differs from the image decoding apparatus 201 shown in FIG. 11 in that only the order of the processes performed by the FIR filter 261 and the motion prediction/compensation unit 262 is changed.

The FIR filter 261 receives, from the lossless decoding unit 211, the filter coefficient h obtained when the lossless decoding unit 211 lossless decodes the header portion. The FIR filter 261 performs a so-called convolution operation expressed by the above-described equation (4) on the reference image supplied from the frame memory 119 via the switch 120 using the filter coefficient h. Thereafter, the FIR filter 261 outputs the filtered reference image to the motion prediction/compensation unit 262.

Like the motion prediction/compensation unit 212 shown in FIG. 11, the motion prediction/compensation unit 262 receives information obtained by lossless decoding the header information (e.g., the information indicating the optimal inter prediction mode, the motion vector information, and the reference frame information) from the lossless decoding unit 211. Like the motion prediction/compensation unit 212, upon receiving the information indicating an optimal inter prediction mode, the motion prediction/compensation unit 262 performs a motion compensation process on the filtered reference image received from the FIR filter 261 in the optimal inter prediction mode indicated by the information using the motion vector information and the reference frame information supplied together with the information indicating the optimal inter prediction mode. Thereafter, the motion prediction/compensation unit 262 outputs the resultant motion-compensated image to the switch 214 as an inter predicted image.

As described above, in inter prediction, the image decoding apparatus 201 shown in FIG. 13 performs a filter process on the reference image before motion compensation is performed on the reference image using the filter coefficient h that is transmitted from the image encoding apparatus 151 and that makes the inter predicted image be similar to the image to be inter predicted. Therefore, inter prediction can be performed more accurately, and the quality of the inter predicted image can be increased.

In addition, since a filter process is performed on the reference image before motion compensation is performed on the reference image, a filter process is also performed even when the motion vector is provided for an integer position. Therefore, even when a motion compensation process with integer-pel accuracy is performed, the quality of an inter predicted image can be increased.

Note that while the above description has been made with reference to the filter coefficient set on a per frame basis, the filter coefficient may be set on a per macroblock basis or a per motion compensation block basis.

While the above description has been made with reference to a macroblock having a size of 16×16 pixels, the present invention can be applied to the extended macroblock size described in “Video Coding Using Extended Block Sizes”, VCEG-AD09, ITU-Telecommunications Standardization Sector STUDY GROUP Question 16—Contribution 123, January 2009.

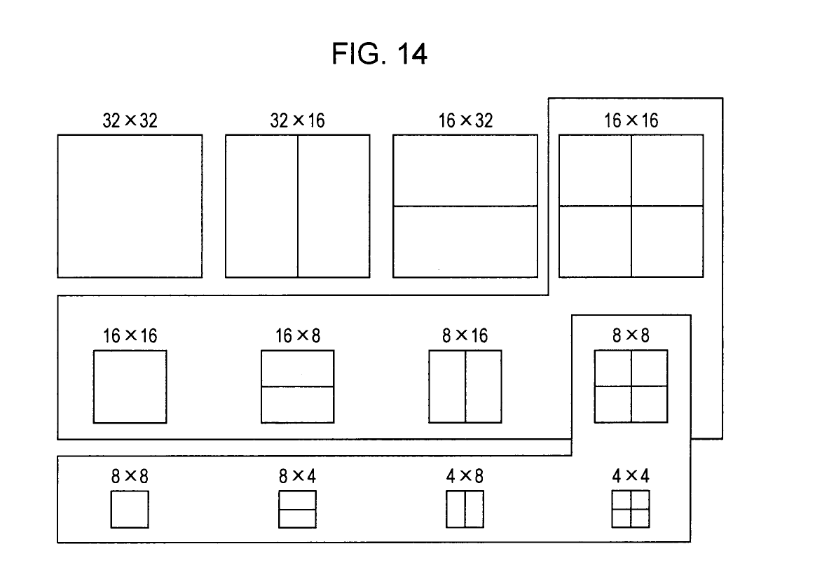

FIG. 14 illustrates an example of the extended macroblock size. In the above description, the macroblock size is extended to a size of 32×32 pixels.

In the upper section of FIG. 14, macroblocks that have a size of 32×32 pixels and that are partitioned into blocks (partitions) having sizes of 32×32 pixels, 32×16 pixels, 16×32 pixels, and 16×16 pixels are shown from the left. In the middle section of FIG. 14, macroblocks that have a size of 16×16 pixels and that are partitioned into blocks having sizes of 16×16 pixels, 16×8 pixels, 8×16 pixels, and 8×8 pixels are shown from the left. In the lower section of FIG. 14, macroblocks that have a size of 8×8 pixels and that are partitioned into blocks having sizes of 8×8 pixels, 8×4 pixels, 4×8 pixels, and 4×4 pixels are shown from the left.

That is, the macroblock having a size of 32×32 can be processed using the blocks having sizes of 32×32 pixels, 32×16 pixels, 16×32 pixels, and 16×16 pixels shown in the upper section of FIG. 14.

In addition, as in the H.264/AVC standard, the block having a size of 16×16 pixels shown on the right in the upper section can be processed using the blocks having sizes of 16×16 pixels, 16×8 pixels, 8×16 pixels, and 8×8 pixels shown in the middle section.

Furthermore, as in the H.264/AVC standard, the block having a size of 8×8 pixels shown on the right in the middle section can be processed using the blocks having sizes of 8×8 pixels, 8×4 pixels, 4×8 pixels, and 4×4 pixels shown in the lower section.

In terms of the extended macroblock size, by employing such a layer structure, for a block having a size smaller than or equal to 16×16 pixels, a block having a larger size can be defined as a superset of the block while maintaining compatibility with the H.264/AVC standard.

Furthermore, the present invention can be applied to the extended macroblock size proposed as described above.

Still furthermore, while the above description has been made with reference to the H.264/AVC standard as an encoding/decoding method, the present invention is applicable to an image encoding apparatus and an image decoding apparatus using another encoding/decoding method in which a motion prediction/compensation process is performed on an another block-size basis.

In addition, the present invention is applicable to an image encoding apparatus and an image decoding apparatus used for receiving image information (a bit stream) compressed through the orthogonal transform (e.g., discrete cosine transform) and motion compensation as in the MPEG or H.26x standard via a network medium, such as satellite broadcasting, a cable TV (television), the Internet, or a cell phone or processing image information in a storage medium such as an optical or magnetic disk, or a flash memory.

The above-described series of processes can be executed not only by hardware but also by software. When the above-described series of processes are executed by software, the programs of the software are installed from a program recording medium into a computer incorporated into dedicated hardware or a computer that can execute a variety of functions by installing a variety of programs therein (e.g., a general-purpose personal computer).

Examples of the program recording medium that records a computer-executable program to be installed in a computer include a magnetic disk (including a flexible disk), an optical disk (including a CD-ROM (Compact Disc-Read Only Memory), a DVD (Digital Versatile Disc), and a magnetooptical disk), a removable medium which is a package medium formed from a semiconductor memory, and a ROM and a hard disk that temporarily or permanently stores the programs. The programs are recorded in the program recording medium using a wired or wireless communication medium, such as a local area network, the Internet, or digital satellite broadcasting, as needed.

In the present specification, the steps that describe the program include not only processes executed in the above-described time-series sequence, but also processes that may be executed in parallel or independently.

In addition, embodiments of the present invention are not limited to the above-described embodiments. Various modifications can be made without departing from the spirit of the present invention.

For example, the above-described image encoding apparatus 151 and image decoding apparatus 201 are applicable to any electronic apparatus. Examples of such application are described below.

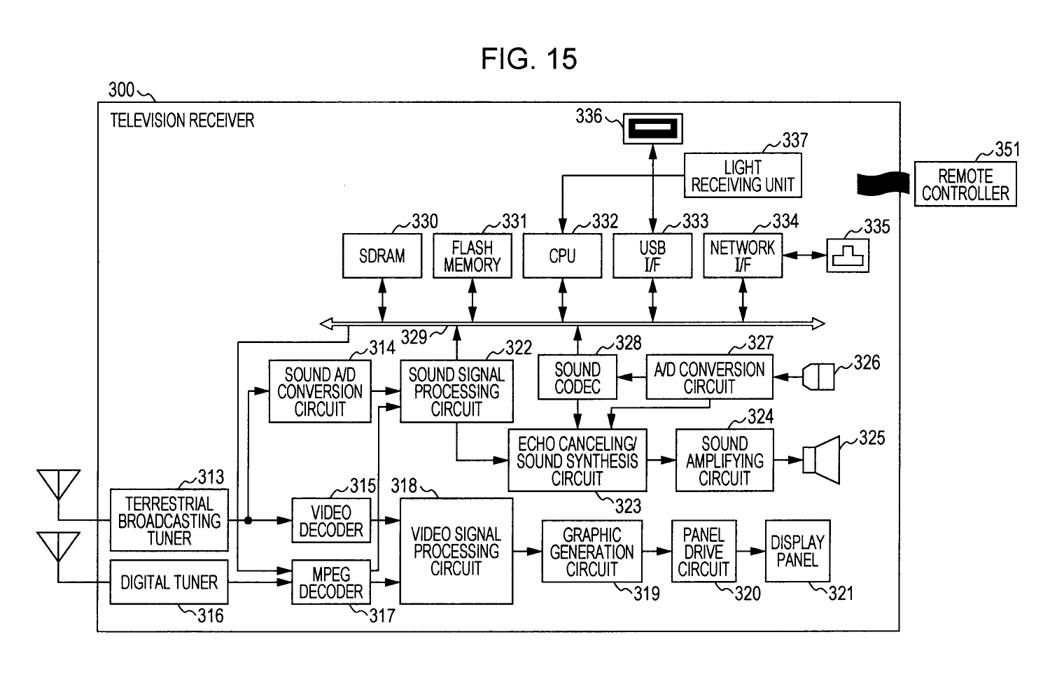

FIG. 15 is a block diagram of an example of the primary configuration of a television receiver using the image decoding apparatus according to the present invention.

As shown in FIG. 15, a television receiver 300 includes a terrestrial broadcasting tuner 313, a video decoder 315, a video signal processing circuit 318, a graphic generation circuit 319, a panel drive circuit 320, and a display panel 321.

The terrestrial broadcasting tuner 313 receives a broadcast signal of analog terrestrial broadcasting via an antenna, demodulates the broadcast signal, acquires a video signal, and supplies the video signal to the video decoder 315. The video decoder 315 performs a decoding process on the video signal supplied from the terrestrial broadcasting tuner 313 and supplies the resultant digital component signal to the video signal processing circuit 318.

The video signal processing circuit 318 performs a predetermined process, such as noise removal, on the video data supplied from the video decoder 315. Thereafter, the video signal processing circuit 318 supplies the resultant video data to the graphic generation circuit 319.

The graphic generation circuit 319 generates, for example, video data for a television program displayed on the display panel 321 and image data generated through the processing performed by an application supplied via a network. Thereafter, the graphic generation circuit 319 supplies the generated video data and image data to the panel drive circuit 320. In addition, the graphic generation circuit 319 generates video data (graphics) for displaying a screen used by a user who selects a menu item. The graphic generation circuit 319 overlays the video data on the video data of the television program. Thereafter, the graphic generation circuit 319 supplies the resultant video data to the panel drive circuit 320 as needed.

The panel drive circuit 320 drives the display panel 321 on the basis of the data supplied from the graphic generation circuit 319. Thus, the panel drive circuit 320 causes the display panel 321 to display the video of a television program and a variety of types of screen thereon.

The display panel 321 includes, for example, an LCD (Liquid Crystal Display). The display panel 321 displays, for example, the video of a television program under the control of the panel drive circuit 320.

The television receiver 300 further includes a sound A/D (Analog/Digital) conversion circuit 314, a sound signal processing circuit 322, an echo canceling/sound synthesis circuit 323, a sound amplifying circuit 324, and a speaker 325.

The terrestrial broadcasting tuner 313 demodulates a received broadcast signal. Thus, the terrestrial broadcasting tuner 313 acquires a sound signal in addition to the video signal. The terrestrial broadcasting tuner 313 supplies the acquired sound signal to the sound A/D conversion circuit 314.

The sound A/D conversion circuit 314 performs an A/D conversion process on the sound signal supplied from the terrestrial broadcasting tuner 313. Thereafter, the sound A/D conversion circuit 314 supplies the resultant digital sound signal to the sound signal processing circuit 322.

The sound signal processing circuit 322 performs a predetermined process, such as noise removal, on the sound data supplied from the sound A/D conversion circuit 314 and supplies the resultant sound data to the echo canceling/sound synthesis circuit 323.

The echo canceling/sound synthesis circuit 323 supplies the sound data supplied from the sound signal processing circuit 322 to the sound amplifying circuit 324.

The sound amplifying circuit 324 performs a D/A conversion process and an amplifying process on the sound data supplied from the echo canceling/sound synthesis circuit 323. After the sound data has a predetermined sound volume, the sound amplifying circuit 324 outputs the sound from the speaker 325.

The television receiver 300 further includes a digital tuner 316 and an MPEG decoder 317.

The digital tuner 316 receives a broadcast signal of digital broadcasting (terrestrial digital broadcasting and BS (Broadcasting Satellite)/CS (Communications Satellite) digital broadcasting) via an antenna and demodulates the broadcast signal. Thus, the digital tuner 316 acquires an MPEG-TS (Moving Picture Experts Group-Transport Stream) and supplies the MPEG-TS to the MPEG decoder 317.

The MPEG decoder 317 descrambles the MPEG-TS supplied from the digital tuner 316 and extracts a stream including television program data to be reproduced (viewed). The MPEG decoder 317 decodes sound packets of the extracted stream and supplies the resultant sound data to the sound signal processing circuit 322. In addition, the MPEG decoder 317 decodes video packets of the stream and supplies the resultant video data to the video signal processing circuit 318. Furthermore, the MPEG decoder 317 supplies EPG (Electronic Program Guide) data extracted from the MPEG-TS to a CPU 332 via a transmission path (not shown).

The television receiver 300 uses the above-described image decoding apparatus 201 as the MPEG decoder 317 that decodes the video packets in this manner. Accordingly, like the image decoding apparatus 201, the MPEG decoder 317 can increase the quality of an inter predicted image even when performing a motion compensation process with integer-pel accuracy.

Like the video data supplied from the video decoder 315, the video data supplied from the MPEG decoder 317 is subjected to a predetermined process in the video signal processing circuit 318. Thereafter, the video data subjected to the predetermined process is overlaid on the generated video data in the graphic generation circuit 319 as needed. The video data is supplied to the display panel 321 via the panel drive circuit 320, and the image based on the video data is displayed.

Like the sound data supplied from the sound A/D conversion circuit 314, the sound data supplied from the MPEG decoder 317 is subjected to a predetermined process in the sound signal processing circuit 322. Thereafter, the sound data subjected to the predetermined process is supplied to the sound amplifying circuit 324 via the echo canceling/sound synthesis circuit 323 and is subjected to a D/A conversion process and an amplifying process. As a result, sound controlled so as to have a predetermined volume is output from the speaker 325.

The television receiver 300 further includes a microphone 326 and an A/D conversion circuit 327.

The A/D conversion circuit 327 receives a user voice signal input from the microphone 326 provided in the television receiver 300 for speech conversation. The A/D conversion circuit 327 performs an A/D conversion process on the received voice signal and supplies the resultant digital voice data to the echo canceling/sound synthesis circuit 323.

When voice data of a user (a user A) of the television receiver 300 is supplied from the A/D conversion circuit 327, the echo canceling/sound synthesis circuit 323 performs echo canceling on the voice data of the user A. After echo canceling is completed, the echo canceling/sound synthesis circuit 323 synthesizes the voice data with other sound data. Thereafter, the echo canceling/sound synthesis circuit 323 outputs the resultant sound data from the speaker 325 via the sound amplifying circuit 324.

The television receiver 300 still further includes a sound codec 328, an internal bus 329, an SDRAM (Synchronous Dynamic Random Access Memory) 330, a flash memory 331, the CPU 332, a USB (Universal Serial Bus) I/F 333, and a network I/F 334.

The A/D conversion circuit 327 receives a user voice signal input from the microphone 326 provided in the television receiver 300 for speech conversation. The A/D conversion circuit 327 performs an A/D conversion process on the received voice signal and supplies the resultant digital voice data to the sound codec 328.

The sound codec 328 converts the sound data supplied from the A/D conversion circuit 327 into data having a predetermined format in order to send the sound data via a network. The sound codec 328 supplies the converted sound data to the network I/F 334 via the internal bus 329.

The network I/F 334 is connected to the network via a cable attached to a network terminal 335. For example, the network I/F 334 sends the sound data supplied from the sound codec 328 to a different apparatus connected to the network. In addition, for example, the network I/F 334 receives sound data sent from a different apparatus connected to the network via the network terminal 335 and supplies the received sound data to the sound codec 328 via the internal bus 329.

The sound codec 328 converts the sound data supplied from the network I/F 334 into data having a predetermined format. The sound codec 328 supplies the converted sound data to the echo canceling/sound synthesis circuit 323.

The echo canceling/sound synthesis circuit 323 performs echo canceling on the sound data supplied from the sound codec 328. Thereafter, the echo canceling/sound synthesis circuit 323 synthesizes the sound data with other sound data and outputs the resultant sound data from the speaker 325 via the sound amplifying circuit 324.

The SDRAM 330 stores a variety of types of data necessary for the CPU 332 to perform processing.

The flash memory 331 stores a program executed by the CPU 332. The program stored in the flash memory 331 is read out by the CPU 332 at a predetermined timing, such as when the television receiver 300 is powered on. The flash memory 331 further stores the EPG data received through digital broadcasting and data received from a predetermined server via the network.

For example, the flash memory 331 stores an MPEG-TS including content data acquired from a predetermined server via the network under the control of the CPU 332. For example, the flash memory 331 supplies the MPEG-TS to the MPEG decoder 317 via the internal bus 329 under the control of the CPU 332.

As in the case of the MPEG-TS supplied from the digital tuner 316, the MPEG decoder 317 processes the MPEG-TS. In this way, the television receiver 300 receives content data including video and sound via the network and decodes the content data using the MPEG decoder 317. Thereafter, the television receiver 300 can display the video and output the sound.

The television receiver 300 still further includes a light receiving unit 337 that receives an infrared signal transmitted from a remote controller 351.

The light receiving unit 337 receives an infrared light beam emitted from the remote controller 351 and demodulates the infrared light beam. Thereafter, the light receiving unit 337 outputs, to the CPU 332, control code that is received through the demodulation and that indicates the type of the user operation.

The CPU 332 executes the program stored in the flash memory 331 and performs overall control of the television receiver 300 in accordance with, for example, the control code supplied from the light receiving unit 337. The CPU 332 is connected to each of the units of the television receiver 300 via a transmission path (not shown).

The USB I/F 333 communicates data with an external device connected to the television receiver 300 via a USB cable attached to a USB terminal 336. The network I/F 334 is connected to the network via a cable attached to the network terminal 335 and also communicates non-sound data with a variety of types of device connected to the network.

By using the image decoding apparatus 201 as the MPEG decoder 317, the television receiver 300 can increase the quality of an inter predicted image even when performing a motion compensation process with integer-pel accuracy. As a result, the television receiver 300 can acquire a higher-resolution decoded image from the broadcast signal received via the antenna or content data received via the network and display the decoded image.

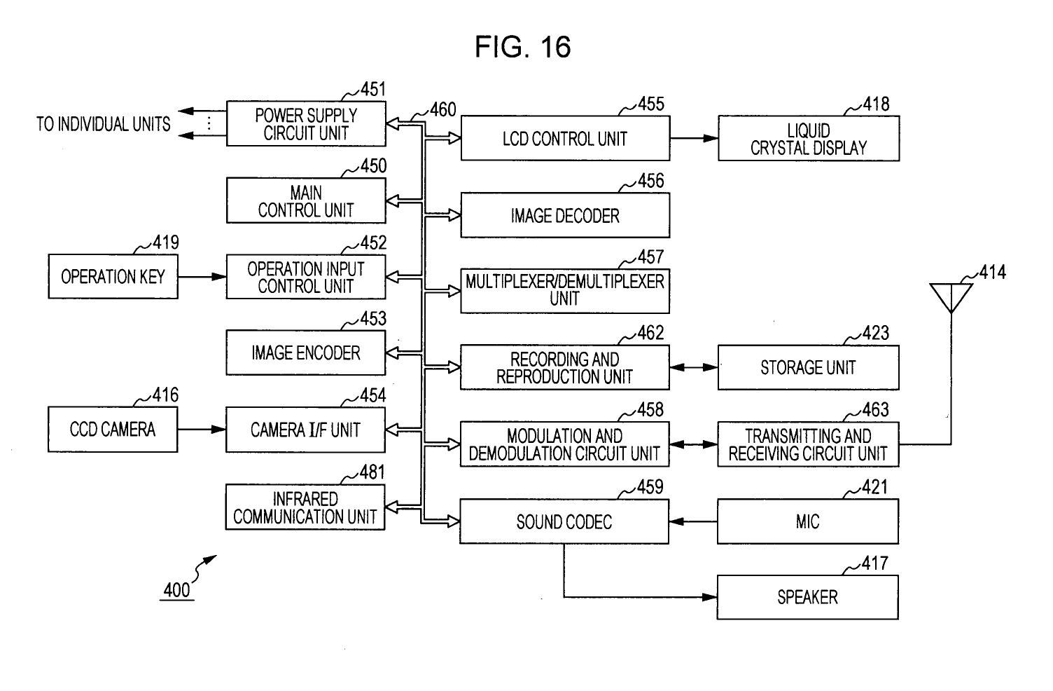

FIG. 16 is a block diagram of an example of a primary configuration of a cell phone using the image encoding apparatus and the image decoding apparatus according to the present invention.

As shown in FIG. 16, a cell phone 400 includes a main control unit 450 that performs overall control of units of the cell phone 400, a power supply circuit unit 451, an operation input control unit 452, an image encoder 453, a camera I/F unit 454, an LCD control unit 455, an image decoder 456, a multiplexer/demultiplexer unit 457, a recording and reproduction unit 462, a modulation and demodulation circuit unit 458, and a sound codec 459. These units are connected to one another via a bus 460.

The cell phone 400 further includes an operation key 419, a CCD (Charge Coupled Devices) camera 416, a liquid crystal display 418, a storage unit 423, a transmitting and receiving circuit unit 463, an antenna 414, a microphone (MIC) 421, and a speaker 417.

When call-ending is performed through a user operation or a power key is turned on, the power supply circuit unit 451 supplies the power from a battery pack to each unit. Thus, the cell phone 400 becomes operable.

Under the control of the main control unit 450 including a CPU, a ROM, and a RAM, the cell phone 400 performs a variety of operations, such as transmitting and receiving a voice signal, transmitting and receiving an e-mail and image data, image capturing, and data recording, in a variety of modes, such as a voice communication mode and a data communication mode.

For example, in the voice communication mode, the cell phone 400 converts a voice signal collected by the microphone (MIC) 421 into digital voice data using the sound codec 459. Thereafter, the cell phone 400 performs a spread spectrum process on the digital voice data using the modulation and demodulation circuit unit 458 and performs a digital-to-analog conversion process and a frequency conversion process on the digital voice data using the transmitting and receiving circuit unit 463. The cell phone 400 transmits a transmission signal obtained through the conversion process to a base station (not shown) via the antenna 414. The transmission signal (the voice signal) transmitted to the base station is supplied to a cell phone of a communication partner via a public telephone network.

In addition, for example, in the voice communication mode, the cell phone 400 amplifies a reception signal received by the antenna 414 using the transmitting and receiving circuit unit 463 and further performs a frequency conversion process and an analog-to-digital conversion process on the reception signal. The cell phone 400 further performs an inverse spread spectrum process on the reception signal using the modulation and demodulation circuit unit 458 and converts the reception signal into an analog voice signal using the sound codec 459. Thereafter, the cell phone 400 outputs the converted analog voice signal from the speaker 417.

Furthermore, for example, upon sending an e-mail in the data communication mode, the cell phone 400 receives text data of an e-mail input through operation of the operation key 419 using the operation input control unit 452. Thereafter, the cell phone 400 processes the text data using the main control unit 450 and displays the text data on the liquid crystal display 418 via the LCD control unit 455 in the form of an image.

Still furthermore, the cell phone 400 generates, using the main control unit 450, e-mail data on the basis of the text data and the user instruction received by the operation input control unit 452. Thereafter, the cell phone 400 performs a spread spectrum process on the e-mail data using the modulation and demodulation circuit unit 458 and performs a digital-to-analog conversion process and a frequency conversion process using the transmitting and receiving circuit unit 463. The cell phone 400 transmits a transmission signal obtained through the conversion processes to a base station (not shown) via the antenna 414. The transmission signal (the e-mail) transmitted to the base station is supplied to a predetermined address via a network and a mail server.

In addition, for example, in order to receive an e-mail in the data communication mode, the cell phone 400 receives a signal transmitted from a base station via the antenna 414 using the transmitting and receiving circuit unit 463, amplifies the signal, and further performs a frequency conversion process and an analog-to-digital conversion process on the signal. The cell phone 400 performs an inverse spread spectrum process on the reception signal and restores the original e-mail data using the modulation and demodulation circuit unit 458. The cell phone 400 displays the restored e-mail data on the liquid crystal display 418 via the LCD control unit 455.

Furthermore, the cell phone 400 can record (store) the received e-mail data in the storage unit 423 via the recording and reproduction unit 462.

The storage unit 423 can be formed from any rewritable storage medium. For example, the storage unit 423 may be formed from a semiconductor memory, such as a RAM or an internal flash memory, a hard disk, or a removable medium, such as a magnetic disk, a magnetooptical disk, an optical disk, a USB memory, or a memory card. However, it should be appreciated that another type of storage medium can be employed.

Still furthermore, in order to transmit image data in the data communication mode, the cell phone 400 generates image data through an image capturing operation performed by the CCD camera 416. The CCD camera 416 includes optical devices, such as a lens and an aperture, and a CCD serving as a photoelectric conversion element. The CCD camera 416 captures the image of a subject, converts the intensity of the received light into an electrical signal, and generates the image data of the subject image. The CCD camera 416 supplies the image data to the image encoder 453 via the camera I/F unit 454. The image encoder 453 compression-encodes the image data using a predetermined coding standard, such as MPEG2 or MPEG4, and converts the image data into encoded image data.

The cell phone 400 employs the above-described image encoding apparatus 151 as the image encoder 453 that performs such a process. Accordingly, like the image encoding apparatus 151, the image encoder 453 can increase the quality of an inter predicted image even when performing a motion compensation process with integer-pel accuracy.

Note that at the same time, the cell phone 400 analog-to-digital converts the sound collected by the microphone (MIC) 421 during the image capturing operation performed by the CCD camera 416 using the sound codec 459 and further performs an encoding process.

The cell phone 400 multiplexes, using the multiplexer/demultiplexer unit 457, the encoded image data supplied from the image encoder 453 with the digital sound data supplied from the sound codec 459 using a predetermined standard. The cell phone 400 performs a spread spectrum process on the resultant multiplexed data using the modulation and demodulation circuit unit 458 and performs a digital-to-analog conversion process and a frequency conversion process using the transmitting and receiving circuit unit 463. The cell phone 400 transmits a transmission signal obtained through the conversion processes to the base station (not shown) via the antenna 414. The transmission signal (the image data) transmitted to the base station is supplied to a communication partner via, for example, the network.

Note that if image data is not transmitted, the cell phone 400 can display the image data generated by the CCD camera 416 on the liquid crystal display 418 via the LCD control unit 455 without using the image encoder 453.

In addition, for example, in order to receive the data of a moving image file linked to, for example, a simplified Web page in the data communication mode, the cell phone 400 receives a signal transmitted from the base station via the antenna 414 using the transmitting and receiving circuit unit 463, amplifies the signal, and further performs a frequency conversion process and an analog-to-digital conversion process on the signal. The cell phone 400 performs an inverse spread spectrum process on the reception signal using the modulation and demodulation circuit unit 458 and restores the original multiplexed data. The cell phone 400 demultiplexes the multiplexed data into the encoded image data and sound data using the multiplexer/demultiplexer unit 457.

By decoding the encoded image data in the image decoder 456 using a decoding standard corresponding to a predetermined encoding standard, such as MPEG2 or MPEG4, the cell phone 400 can generate reproduction moving image data and displays the reproduction moving image data on the liquid crystal display 418 via the LCD control unit 455. Thus, for example, moving image data included in a moving image file linked to a simplified Web page can be displayed on the liquid crystal display 418.

The cell phone 400 employs the above-described image decoding apparatus 201 as the image decoder 456 that performs such a process. Accordingly, like the image decoding apparatus 201, the image decoder 456 can increase the quality of an inter predicted image even when performing a motion compensation process with integer-pel accuracy.

At the same time, the cell phone 400 converts the digital sound data into an analog sound signal using the sound codec 459 and outputs the analog sound signal from the speaker 417. In this way, for example, the sound data included in the moving image file linked to the simplified Web page can be reproduced.

Note that as in the case of an e-mail, the cell phone 400 can record (store) the data linked to, for example, a received simplified Web page in the storage unit 423 via the recording and reproduction unit 462.

In addition, the cell phone 400 can analyze a two-dimensional code obtained through an image capturing operation performed by the CCD camera 416 using the main control unit 450 and acquire the information recorded as the two-dimensional code.

Furthermore, the cell phone 400 can communicate with an external device using an infrared communication unit 481 and infrared light.

By using the image encoding apparatus 151 as the image encoder 453, the cell phone 400 can increase the coding efficiency for encoding, for example, the image data generated by the CCD camera 416 and generating encoded data. As a result, the cell phone 400 can provide encoded data (image data) with excellent coding efficiency to another apparatus.

In addition, by using the image decoding apparatus 201 as the image decoder 456, the cell phone 400 can generate a high-accuracy predicted image. As a result, the cell phone 400 can acquire a higher-resolution decoded image from a moving image file linked to a simplified Web page and display the higher-resolution decoded image.

Note that while the above description has been made with reference to the cell phone 400 using the CCD camera 416, an image sensor using a CMOS (Complementary Metal Oxide Semiconductor) (i.e., a CMOS image sensor) may be used instead of the CCD camera 416. Even in such a case, as in the case of using the CCD camera 416, the cell phone 400 can capture the image of a subject and generate the image data of the image of the subject.

In addition, while the above description has been made with reference to the cell phone 400, the image encoding apparatus 151 and the image decoding apparatus 201 can be applied to any apparatus having an image capturing function and a communication function that are similar to those of the cell phone 400, such as a PDA (Personal Digital Assistant), a smart phone, a UMPC (Ultra Mobile Personal Computer), a netbook, or a laptop personal computer, as to the cell phone 400.

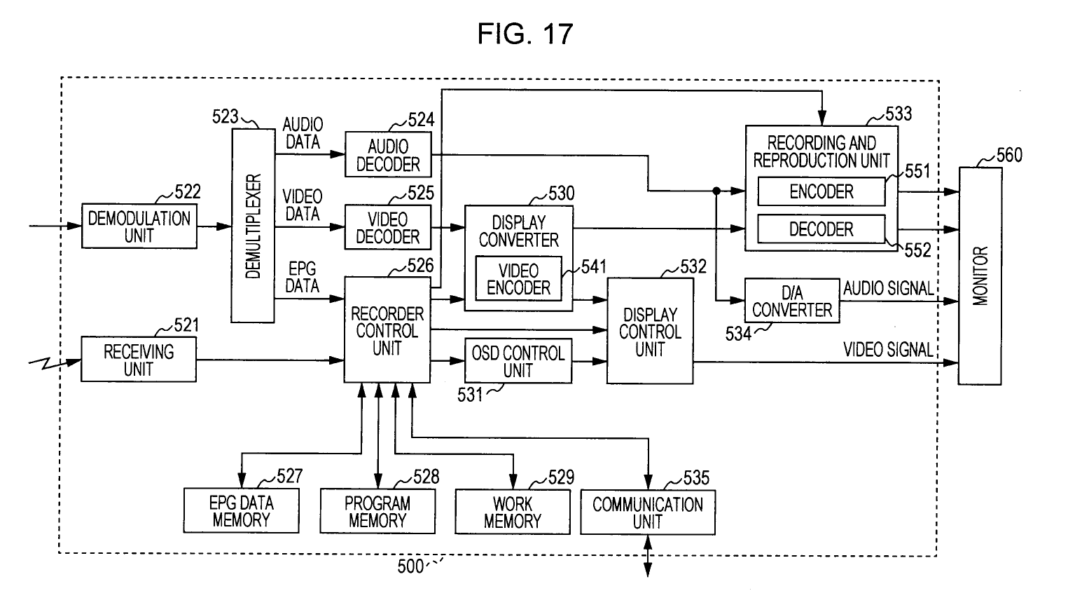

FIG. 17 is a block diagram of an example of the primary configuration of a hard disk recorder using the image encoding apparatus and the image decoding apparatus according to the present invention.

As shown in FIG. 17, a hard disk recorder (HDD recorder) 500 stores, in an internal hard disk, audio data and video data of a broadcast program included in a broadcast signal (a television program) emitted from, for example, a satellite or a terrestrial antenna and received by a tuner. Thereafter, the hard disk recorder 500 provides the stored data to a user at a timing instructed by the user.

The hard disk recorder 500 can extract audio data and video data from, for example, the broadcast signal, decode the data as needed, and store the data in the internal hard disk. In addition, the hard disk recorder 500 can acquire audio data and video data from another apparatus via, for example, a network, decode the data as needed, and store the data in the internal hard disk.

Furthermore, the hard disk recorder 500 can decode audio data and video data stored in, for example, the internal hard disk and supply the decoded audio data and video data to a monitor 560. Thus, the image can be displayed on the screen of the monitor 560. In addition, the hard disk recorder 500 can output the sound from a speaker of the monitor 560.

For example, the hard disk recorder 500 decodes audio data and video data extracted from the broadcast signal received via the tuner or audio data and video data acquired from another apparatus via a network. Thereafter, the hard disk recorder 500 supplies the decoded audio data and video data to the monitor 560, which displays the image of the video data on the screen of the monitor 560. In addition, the hard disk recorder 500 can output the sound from the speaker of the monitor 560.

It should be appreciated that the hard disk recorder 500 can perform other operations.

As shown in FIG. 17, the hard disk recorder 500 includes a receiving unit 521, a demodulation unit 522, a demultiplexer 523, an audio decoder 524, a video decoder 525, and a recorder control unit 526. The hard disk recorder 500 further includes an EPG data memory 527, a program memory 528, a work memory 529, a display converter 530, an OSD (On Screen Display) control unit 531, a display control unit 532, a recording and reproduction unit 533, a D/A converter 534, and a communication unit 535.

Furthermore, the display converter 530 includes a video encoder 541. The recording and reproduction unit 533 includes an encoder 551 and a decoder 552.

The receiving unit 521 receives an infrared signal transmitted from a remote controller (not shown) and converts the infrared signal into an electrical signal. Thereafter, the receiving unit 521 outputs the electrical signal to the recorder control unit 526. The recorder control unit 526 is formed from, for example, a microprocessor. The recorder control unit 526 performs a variety of processes in accordance with a program stored in the program memory 528. At that time, the recorder control unit 526 uses the work memory 529 as needed.

The communication unit 535 is connected to a network and performs a communication process with another apparatus connected thereto via the network. For example, the communication unit 535 is controlled by the recorder control unit 526 and communicates with a tuner (not shown). The communication unit 535 mainly outputs a channel selection control signal to the tuner.

The demodulation unit 522 demodulates the signal supplied from the tuner and outputs the demodulated signal to the demultiplexer 523. The demultiplexer 523 demultiplexes the data supplied from the demodulation unit 522 into audio data, video data, and EPG data and outputs these data items to the audio decoder 524, the video decoder 525, and the recorder control unit 526, respectively.

The audio decoder 524 decodes the input audio data using, for example, the MPEG standard and outputs the decoded audio data to the recording and reproduction unit 533. The video decoder 525 decodes the input video data using, for example, the MPEG standard and outputs the decoded video data to the display converter 530. The recorder control unit 526 supplies the input EPG data to the EPG data memory 527, which stores the EPG data.

The display converter 530 encodes the video data supplied from the video decoder 525 or the recorder control unit 526 into, for example, NTSC (National Television Standards Committee) video data using the video encoder 541 and outputs the encoded video data to the recording and reproduction unit 533. In addition, the display converter 530 converts the screen size for the video data supplied from the video decoder 525 or the recorder control unit 526 into a size corresponding to the size of the monitor 560. The display converter 530 further converts the video data having the converted screen size into NTSC video data using the video encoder 541 and converts the video data into an analog signal. Thereafter, the display converter 530 outputs the analog signal to the display control unit 532.

Under the control of the recorder control unit 526, the display control unit 532 overlays an OSD signal output from the OSD (On Screen Display) control unit 531 on a video signal input from the display converter 530 and outputs the overlaid signal to the monitor 560, which displays the image.

In addition, the audio data output from the audio decoder 524 is converted into an analog signal by the D/A converter 534 and is supplied to the monitor 560. The monitor 560 outputs the audio signal from a speaker incorporated therein.

The recording and reproduction unit 533 includes a hard disk serving as a storage medium for recording video data and audio data.

For example, the recording and reproduction unit 533 MPEG-encodes the audio data supplied from the audio decoder 524 using the encoder 551. In addition, the recording and reproduction unit 533 MPEG-encodes the video data supplied from the video encoder 541 of the display converter 530 using the encoder 551. The recording and reproduction unit 533 multiplexes the encoded audio data with the encoded video data using a multiplexer so as to synthesize the data. The recording and reproduction unit 533 amplifies the synthesized data by channel coding and writes the data into the hard disk via a recording head.

The recording and reproduction unit 533 reproduces the data recorded in the hard disk via a reproducing head, amplifies the data, and separates the data into audio data and video data using the demultiplexer. The recording and reproduction unit 533 MPEG-decodes the audio data and video data using the decoder 552. The recording and reproduction unit 533 D/A-converts the decoded audio data and outputs the converted audio data to the speaker of the monitor 560. In addition, the recording and reproduction unit 533 D/A-converts the decoded video data and outputs the converted video data to the display of the monitor 560.

The recorder control unit 526 reads the latest EPG data from the EPG data memory 527 in response to a user instruction indicated by an infrared signal emitted from the remote controller and received via the receiving unit 521. Thereafter, the recorder control unit 526 supplies the EPG data to the OSD control unit 531. The OSD control unit 531 generates image data corresponding to the input EPG data and outputs the image data to the display control unit 532. The display control unit 532 outputs the video data input from the OSD control unit 531 to the display of the monitor 560, which displays the video data. In this way, the EPG (electronic program guide) is displayed on the display of the monitor 560.

In addition, the hard disk recorder 500 can acquire a variety of types of data, such as video data, audio data, or EPG data, supplied from a different apparatus via a network, such as the Internet.

The communication unit 535 is controlled by the recorder control unit 526. The communication unit 535 acquires encoded data, such as video data, audio data, and EPG data, transmitted from a different apparatus via a network and supplies the encoded data to the recorder control unit 526. The recorder control unit 526 supplies, for example, the acquired encoded video data and audio data to the recording and reproduction unit 533, which stores the data in the hard disk. At that time, the recorder control unit 526 and the recording and reproduction unit 533 may re-encode the data as needed.

In addition, the recorder control unit 526 decodes the acquired encoded video data and audio data and supplies the resultant video data to the display converter 530. In the same manner for the video data supplied from the video decoder 525, the display converter 530 processes the video data supplied from the recorder control unit 526 and supplies the video data to the monitor 560 via the display control unit 532 so that the image is displayed.

In addition, at the same time as displaying the image, the recorder control unit 526 may supply the decoded audio data to the monitor 560 via the D/A converter 534 and output the sound from the speaker.

Furthermore, the recorder control unit 526 decodes the acquired encoded EPG data and supplies the decoded EPG data to the EPG data memory 527.

The above-described hard disk recorder 500 uses the image decoding apparatus 201 as each of the decoders included in the video decoder 525, the decoder 552, and the recorder control unit 526. Accordingly, like the image decoding apparatus 201, the decoder included in each of the video decoder 525, the decoder 552, and the recorder control unit 526 can increase the quality of an inter predicted image even when performing a motion compensation process with integer-pel accuracy.

Therefore, the hard disk recorder 500 can generate a high-accuracy predicted image. As a result, the hard disk recorder 500 can acquire a higher-resolution decoded image from encoded video data received via the tuner, encoded video data read from the hard disk of the recording and reproduction unit 533, or encoded video data acquired via the network and display the higher-resolution decoded image on the monitor 560.

In addition, the hard disk recorder 500 uses the image encoding apparatus 151 as the encoder 551. Accordingly, like the image encoding apparatus 151, the encoder 551 can increase the quality of an inter predicted image even when performing a motion compensation process with integer-pel accuracy.

Accordingly, for example, the hard disk recorder 500 can increase the coding efficiency for the encoded data stored in the hard disk. As a result, the hard disk recorder 500 can use the storage area of the hard disk more efficiently.

Note that while the above description has been made with reference to the hard disk recorder 500 that records video data and audio data in the hard disk, it should be appreciated that any recording medium can be employed. For example, like the above-described hard disk recorder 500, the image encoding apparatus 151 and the image decoding apparatus 201 can be applied to even a recorder that uses a recording medium other than a hard disk (e.g., a flash memory, an optical disk, or a video tape).

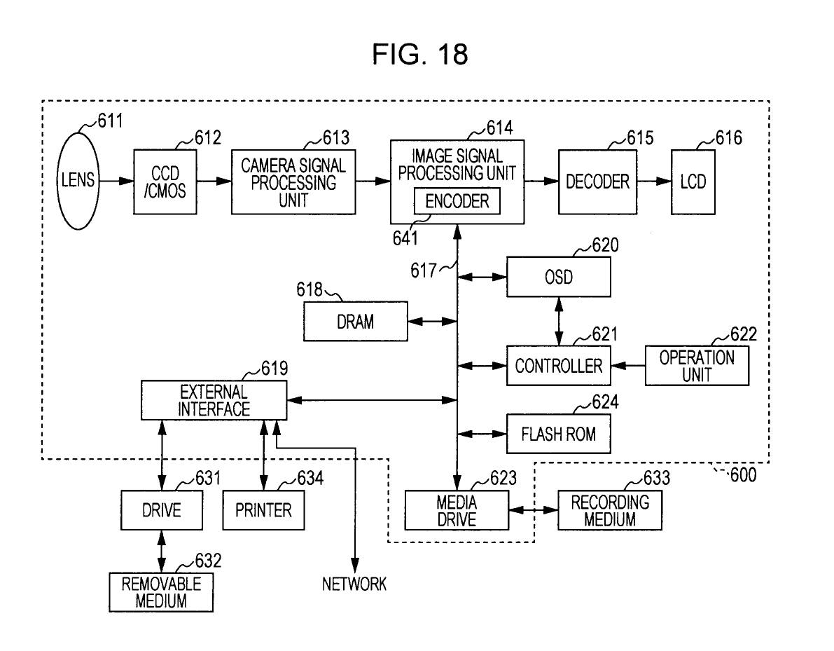

FIG. 18 is a block diagram of an example of the primary configuration of a camera using the image decoding apparatus and the image encoding apparatus according to the present invention.

A camera 600 shown in FIG. 18 captures the image of a subject and instructs an LCD 616 to display the image of the subject thereon or stores the image in a recording medium 633 in the form of image data.

A lens block 611 causes the light (i.e., the video of the subject) to be incident on a CCD/CMOS 612. The CCD/CMOS 612 is an image sensor using a CCD or a CMOS. The CCD/CMOS 612 converts the intensity of the received light into an electrical signal and supplies the electrical signal to a camera signal processing unit 613.

The camera signal processing unit 613 converts the electrical signal supplied from the CCD/CMOS 612 into Y, Cr, Cb color difference signals and supplies the color difference signals to an image signal processing unit 614. Under the control of a controller 621, the image signal processing unit 614 performs a predetermined image process on the image signal supplied from the camera signal processing unit 613 or encodes the image signal using an encoder 641 and, for example, the MPEG standard. The image signal processing unit 614 supplies encoded data generated by encoding the image signal to a decoder 615. In addition, the image signal processing unit 614 acquires display data generated by an on screen display (OSD) 620 and supplies the display data to the decoder 615.

In the above-described processing, the camera signal processing unit 613 uses a DRAM (Dynamic Random Access Memory) 618 connected thereto via a bus 617 as needed and stores, in the DRAM 618, encoded data obtained by encoding the image data as needed.

The decoder 615 decodes the encoded data supplied from the image signal processing unit 614 and supplies the resultant image data (the decoded image data) to the LCD 616. In addition, the decoder 615 supplies the display data supplied from the image signal processing unit 614 to the LCD 616. The LCD 616 combines an image of the decoded image data supplied from the decoder 615 with an image of the display data as needed and displays the combined image.

Under the control of the controller 621, the on screen display 620 outputs the display data, such as a menu screen including symbols, characters, or graphics and icons, to the image signal processing unit 614 via the bus 617.

The controller 621 performs a variety of types of processing on the basis of a signal indicating a user instruction input through the operation unit 622 and controls the image signal processing unit 614, the DRAM 618, an external interface 619, the on screen display 620, and a media drive 623 via the bus 617. A FLASH ROM 624 stores a program and data necessary for the controller 621 to perform the variety of types of processing.

For example, the controller 621 can encode the image data stored in the DRAM 618 and decode the encoded data stored in the DRAM 618 instead of the image signal processing unit 614 and the decoder 615. At that time, the controller 621 may perform the encoding/decoding process using the encoding/decoding method employed by the image signal processing unit 614 and the decoder 615. Alternatively, the controller 621 may perform the encoding/decoding process using an encoding/decoding method different from that employed by the image signal processing unit 614 and the decoder 615.

In addition, for example, when instructed to print an image from the operation unit 622, the controller 621 reads the encoded data from the DRAM 618 and supplies, via the bus 617, the encoded data to a printer 634 connected to the external interface 619 via the external interface 619. Thus, the image data is printed.

Furthermore, for example, when instructed to record an image from the operation unit 622, the controller 621 reads the encoded data from the DRAM 618 and supplies, via the bus 617, the encoded data to the recording medium 633 mounted in the media drive 623. Thus, the image data is stored in the recording medium 633.

Examples of the recording medium 633 include a readable and writable removable medium, such as a magnetic disk, a magnetooptical disk, an optical disk, or a semiconductor memory. It should be appreciated that the recording medium 633 is of any removable medium type, such as a tape device, a disk, or a memory card. Alternatively, the recording medium 633 may be a non-contact IC card.

Alternatively, the media drive 623 may be integrated into the recording medium 633. For example, like an internal hard disk drive or an SSD (Solid State Drive), a non-removable storage medium can be used as the media drive 623 and the recording medium 633.

The external interface 619 is formed from, for example, a USB input/output terminal. When an image is printed, the external interface 619 is connected to the printer 634. In addition, a drive 631 is connected to the external interface 619 as needed. Thus, a removable medium 632, such as a magnetic disk, an optical disk, or a magnetooptical disk, is mounted as needed. A computer program read from the removable medium 632 is installed in the FLASH ROM 624 as needed.

Furthermore, the external interface 619 includes a network interface connected to a predetermined network, such as a LAN or the Internet. For example, in response to an instruction received from the operation unit 622, the controller 621 can read the encoded data from the DRAM 618 and supply the encoded data from the external interface 619 to another apparatus connected thereto via the network. In addition, the controller 621 can acquire, using the external interface 619, encoded data and image data supplied from another apparatus via the network and store the data in the DRAM 618 or supply the data to the image signal processing unit 614.

The above-described camera 600 uses the image decoding apparatus 201 as the decoder 615. Accordingly, like the image decoding apparatus 201, the decoder 615 can increase the quality of an inter predicted image even when performing a motion compensation process with integer-pel accuracy.

Therefore, the camera 600 can generate a high-accuracy predicted image. As a result, the camera 600 can acquire a higher-resolution decoded image from, for example, the image data generated by the CCD/CMOS 612, the encoded data of video data read from the DRAM 618 or the recording medium 633, or the encoded data of video data received via a network and display the decoded image on the LCD 616.

In addition, the camera 600 uses the image encoding apparatus 151 as the encoder 641. Accordingly, like the image encoding apparatus 151, the encoder 641 can increase the quality of an inter predicted image even when performing a motion compensation process with integer-pel accuracy.

Accordingly, for example, the camera 600 can increase the coding efficiency for the encoded data recorded in the hard disk. As a result, the camera 600 can use the storage area of the DRAM 618 and the storage area of the recording medium 633 more efficiently.

Note that the decoding technique employed by the image decoding apparatus 201 may be applied to the decoding process performed by the controller 621. Similarly, the encoding technique employed by the image encoding apparatus 151 may be applied to the encoding process performed by the controller 621.

In addition, the image data captured by the camera 600 may be a moving image or a still image.

It should be appreciated that the image encoding apparatus 151 and the image decoding apparatus 201 are applicable to apparatuses or systems other than the above-described apparatus.

### REFERENCE SIGNS LIST

63, 70, 115 computing unit
67 accumulation buffer
151 image encoding apparatus
161 motion prediction/compensation unit
162 filter coefficient computing unit
163 FIR filter
201 image decoding apparatus
212 motion prediction/compensation unit
213 FIR filter

1. An image processing apparatus comprising:
decoding means for decoding an encoded image;
filter processing means for performing a filter process, using a filter coefficient transmitted from a different image processing apparatus that encoded the image and corresponding to the encoded image, the filter coefficient being obtained so that one of a reference image of the image and a motion-compensated reference image is made to be similar to the image prior to an encoding process when the image is encoded, on one of the image decoded by the decoding means and the motion compensated image;
motion compensating means for performing motion compensation on one of the image filtered by the filter processing means and the image decoded by the decoding means; and
computing means for generating a decoded image by summing the image decoded by the decoding means and one of the filtered image that is motion-compensated by the motion compensating means and the motion-compensated image that is filtered by the filter processing means.

2. The image processing apparatus according to claim 1, wherein the filter processing means performs a filter process on the image decoded by the decoding means, and wherein the motion compensating means performs motion compensation on the image that is filtered by the filter processing means, and wherein the computing means generates the decoded image by summing the image decoded by the decoding means and the filtered image that is motion-compensated by the motion compensating means.

3. The image processing apparatus according to claim 1, wherein the motion compensating means performs motion compensation on the image decoded by the decoding means, and wherein the filter processing means performs a filter process on the image that is motion-compensated by the motion compensating means, and wherein the computing means generates the decoded image by summing the image decoded by the decoding means and the motion-compensated image that is filtered by the filter processing means.

4. The image processing apparatus according to claim 1, wherein the filter coefficient is obtained using a least square method when the image is encoded so that the square of a difference between the image prior to encoding and one of a reference image of the image and the motion compensated reference image is minimized.

5. The image processing apparatus according to claim 1, wherein the filter coefficient and the encoded image are lossless-encoded and transmitted from the different image processing apparatus in the form of compression information, and wherein the decoding means lossless-decodes the compression information, extracts the filter coefficient and the encoded image from the resultant information, and decodes the encoded image, and wherein the filter processing means performs a filter process on one of the image decoded by the decoding means and the motion-compensated image using the filter coefficient extracted by the decoding means.

6. An image processing method for use in an image processing apparatus, comprising:
a decoding step of decoding an encoded image;
a filter processing step of performing a filter process on one of the image decoded by the decoding means and the motion compensated image using a filter coefficient transmitted from a different image processing apparatus that encoded the image and corresponding to the encoded image, the filter coefficient being obtained so that one of a reference image of the image and a motion-compensated image is made to be similar to the image prior to an encoding process when the image is encoded;
a motion compensating step of performing motion compensation on one of the image filtered in the filter processing step and the image decoded in the decoding step; and
a computing step of generating a decoded image by summing the image decoded in the decoding step and one of the filtered image that is motion-compensated in the motion compensating step and the motion-compensated image that is filtered in the filter processing step.

7. A program comprising:
program code for causing a computer to function as an image processing apparatus, the image processing apparatus including decoding means for decoding an encoded image, filter processing means for performing a filter process, using a filter coefficient transmitted from a different image processing apparatus that encoded the image and corresponding to the encoded image, the filter coefficient being obtained so that one of a reference image of the image and a motion-compensated image is made to be similar to the image prior to an encoding process when the image is encoded, on one of the image decoded by the decoding means and the motion compensated image, motion compensating means for performing motion compensation on one of the image filtered by the filter processing means and the image decoded by the decoding means, and computing means for generating a decoded image by summing the image decoded by the decoding means and one of the filtered image that is motion-compensated by the motion compensating means and the motion-compensated image that is filtered by the filter processing means.

8. An image processing apparatus comprising:
filter coefficient computing means for computing, using an image to be encoded and one of a reference image and a motion-compensated reference image, a filter coefficient of a filter that makes one of the reference image and the motion-compensated reference image be similar to the image to be encoded;
filter processing means for performing a filter process on one of the reference image and the motion-compensated reference image using the filter coefficient computed by the filter coefficient computing means;
motion compensating means for detecting, using the image to be encoded and one of the filtered reference image and the reference image, a motion vector between the image to be encoded and one of the filtered reference image and the reference image and performing motion compensation on one of the filtered reference image and the reference image on the basis of the motion vector;
encoding means for generating the encoded image using a difference between the image to be encoded and one of the motion-compensated filtered reference image and the filtered motion-compensated reference image; and
transmitting means for transmitting the encoded image and the filter coefficient.

9. The image processing apparatus according to claim 8, wherein the filter coefficient computing means computes the filter coefficient of a filter that makes the reference image be similar to the image to be encoded on the basis of the image to be encoded and the reference image, and wherein the filter processing means performs a filter process on the reference image using the filter coefficient, and wherein the motion compensating means detects a motion vector between the image to be encoded and the filtered reference image using the image to be encoded and the filtered reference image and performs motion compensation on the filtered reference image on the basis of the motion vector, and wherein the encoding means generates the encoded image using a difference between the motion-compensated filtered image and the image to be encoded.

10. The image processing apparatus according to claim 8, wherein the motion compensating means detects, using the image to be encoded and the reference image, a motion vector between the image to be encoded and the reference image and performs motion compensation on the reference image on the basis of the motion vector, and wherein the filter coefficient computing means computes a filter coefficient of a filter that makes the motion-compensated reference image be similar to the image to be encoded on the basis of the image to be encoded and the motion-compensated reference image, and wherein the filter processing means performs a filter process on the motion-compensated reference image using the filter coefficient, and wherein the encoding means generates the encoded image using a difference between the filtered motion-compensated reference image and the image to be encoded.

11. The image processing apparatus according to claim 8, wherein the filter coefficient computing means computes the filter coefficient using a least square method so that the square of a difference between the image to be encoded and one of the reference image and the motion-compensated reference image is minimized.

12. The image processing apparatus according to claim 8, wherein the filter coefficient computing means computes the filter coefficient using a pixel value of one of the reference image and the motion-compensated reference image with integer-pel accuracy and a pixel value of one of the reference image and the motion-compensated reference image with fractional-pel accuracy.

13. The image processing apparatus according to claim 8, wherein the transmitting means lossless-encodes the encoded image and the filter coefficient and transmits the encoded image and the filter coefficient in the form of compression information.

14. An image processing method for use in an image processing apparatus, comprising:
a filter coefficient computing step of computing, using an image to be encoded and one of a reference image and a motion-compensated image, a filter coefficient of a filter that makes one of the reference image and the motion-compensated image be similar to the image to be encoded;
a filter processing step of performing a filter process on one of the reference image and the motion-compensated image using the filter coefficient computed in the filter coefficient computing step;
a motion compensating step of detecting, using one of the filtered reference image and the reference image, a motion vector between the image to be encoded and one of the filtered reference image and the reference image and performing motion compensation on one of the filtered reference image and the reference image on the basis of the motion vector;
an encoding step of generating the encoded image using a difference between the image to be encoded and one of the motion-compensated filtered reference image and the filtered motion-compensated reference image; and
a transmitting step of transmitting the encoded image and the filter coefficient.

15. A program comprising:
program code for causing a computer to function as an image processing apparatus, the image processing apparatus including filter coefficient computing means for computing, using an image to be encoded and one of a reference image and a motion-compensated reference image, a filter coefficient of a filter that makes one of the reference image and the motion-compensated reference image be similar to the image to be encoded, filter processing means for performing a filter process on one of the reference image and the motion-compensated reference image using the filter coefficient computed by the filter coefficient computing means, motion compensating means for detecting, using the image to be encoded and one of the filtered reference image and the reference image, a motion vector between the image to be encoded and one of the filtered reference image and the reference image and performing motion compensation on one of the filtered reference image and the reference image on the basis of the motion vector, encoding means for generating the encoded image using a difference between the image to be encoded and one of the motion-compensated filtered reference image and the filtered motion-compensated reference image, and transmitting means for transmitting the encoded image and the filter coefficient.
